(19) United States
(12) Patent Application Publication
(10) Pub. No.: US 2025/0039071 A1
(43) Pub. Date: Jan. 30, 2025

(54) NETWORK DEVICE AND MODEL LEARNING METHOD

(71) Applicant: Fujitsu Limited, Kawasaki-shi Kanagawa (JP)

(72) Inventors: Katsunori SETO, Yokohama (JP); Takuya NITTA, Machida (JP); Kohei ICHIMURA, Fuchu (JP); Rikiya WATANABE, Kawasaki (JP)

(73) Assignee: Fujitsu Limited, Kawasaki-shi Kanagawa (JP)

(21) Appl. No.: 18/752,977

(22) Filed: Jun. 25, 2024

(30) Foreign Application Priority Data
Jul. 28, 2023 (JP) 2023-123855

(51) Int. Cl. H04L 43/08; H04L 41/16

(52) U.S. Cl. CPC H04L 43/08; H04L 41/16

(57) ABSTRACT

A network device includes: a memory; and a processor coupled to the memory and the processor configured to: calculate, based on acquisition statuses of packets in a capture device that acquires the packets transmitted from an application device to a terminal device over a network, first group information indicating the acquisition statuses for each of a plurality of packet groups each including a plurality of packets having a predetermined relationship with each other; and generate a learning model by learning teacher data including the first group information calculated, first communication condition information indicating communication conditions of the packets in the network, and first quality information indicating quality in terms of output of the packets on the terminal device.

### CROSS-REFERENCE TO RELATED APPLICATION

This application is based upon and claims the benefit of priority of the prior Japanese Patent Application No. 2023-123855, filed on Jul. 28, 2023, the entire contents of which are incorporated herein by reference.

### FIELD

The present invention relates to a network device and a model learning method.

### BACKGROUND

In a moving image distribution system that distributes moving image data to a terminal device over a network (hereinafter also referred to simply as “moving image distribution system” or “information processing system”), for instance, based on correlation between information indicating communication conditions, e.g., a delay time and a packet loss rate, in the network (hereinafter also referred to as “communication condition information”) and information indicating the quality of moving image data reproduced on the terminal device (hereinafter also referred to as “quality information”), a piece of communication condition information that is able to be determined as having a significant effect on the quality information is identified. Then, in the moving image distribution system, for instance, a learning model capable of estimating quality information (hereinafter also referred to simply as “learning model”) is generated through learning of the identified piece of communication condition information as an explanatory variable (see Japanese Patent Application Publication No. 2021-193832 and Japanese Patent Application Publication No. 2018-137499, for instance).

### SUMMARY

According to an aspect of the embodiments, a network device includes: a memory; and a processor coupled to the memory and the processor configured to: calculate, based on acquisition statuses of packets in a capture device that acquires the packets transmitted from an application device to a terminal device over a network, first group information indicating the acquisition statuses for each of a plurality of packet groups each including a plurality of packets having a predetermined relationship with each other; and generate a learning model by learning teacher data including the first group information calculated, first communication condition information indicating communication conditions of the packets in the network, and first quality information indicating quality in terms of output of the packets on the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for illustrating a configuration of an information processing system 10.

FIG. 2 is a diagram for illustrating a configuration of the information processing system 10.

FIG. 3 is a diagram for illustrating a hardware configuration of an information processing device 1.

FIG. 4 is a diagram for illustrating functions of the information processing device 1 according to a first embodiment.

FIG. 5 is a diagram for illustrating the functions of the information processing device 1 according to the first embodiment.

FIG. 6 is a flowchart for illustrating an outline of a learning process according to the first embodiment.

FIG. 7 is a flowchart for illustrating details of the learning process according to the first embodiment.

FIG. 8 is a flowchart for illustrating details of the learning process according to the first embodiment.

FIG. 9 is a flowchart for illustrating details of the learning process according to the first embodiment.

FIG. 10 is a flowchart for illustrating details of the learning process according to the first embodiment.

FIG. 11 is a flowchart for illustrating details of the learning process according to the first embodiment.

FIG. 12 is a flowchart for illustrating details of the learning process according to the first embodiment.

FIG. 13 is a flowchart for illustrating details of the learning process according to the first embodiment.

FIG. 14 is a diagram for illustrating a specific example of quality information 132.

FIG. 15 is a diagram for illustrating a specific example of communication condition information 133.

FIG. 16 is a diagram for illustrating a specific example of group communication information 134a.

FIG. 17 is a diagram for illustrating a specific example of the group communication information 134a.

FIG. 18 is a diagram for illustrating a specific example of the group communication information 134a.

FIG. 19 is a diagram for illustrating a specific example of the group communication information 134a.

FIG. 20 is a diagram for illustrating details of the learning process according to the first embodiment.

FIG. 21 is a diagram for illustrating a specific example of group totalization information 134b.

FIG. 22 is a diagram for illustrating a specific example of teacher data DT.

FIG. 23 is a flowchart for illustrating an estimation process according to the first embodiment.

FIG. 24 is a diagram for illustrating the estimation process according to the first embodiment.

FIG. 25 is a diagram for illustrating the estimation process according to the first embodiment.

### DESCRIPTION OF EMBODIMENTS

Hereinafter, embodiments of the present disclosure will be described with reference to the drawings. However, the following description is not intended to be construed as limiting, and the subject matter recited in the claims is not limited thereto. Also, various modifications, substitutions, and alterations are able to be made thereto without departing from the gist and scope of the present disclosure. Furthermore, different embodiments may be combined as appropriate.

In moving image distribution systems as described above, for instance, there are cases where the correlation between the timing at which a change in communication condition information occurs in the network and the timing at which a change in quality information occurs on the terminal device is not sufficiently strong. Accordingly, in the moving image distribution systems, for instance, there are cases where quality information is not able to be estimated with high accuracy even when a learning model as described above is used. Hereinafter, a configuration of an information processing system 10 will be described.

### Configuration of Information Processing System according to First Embodiment

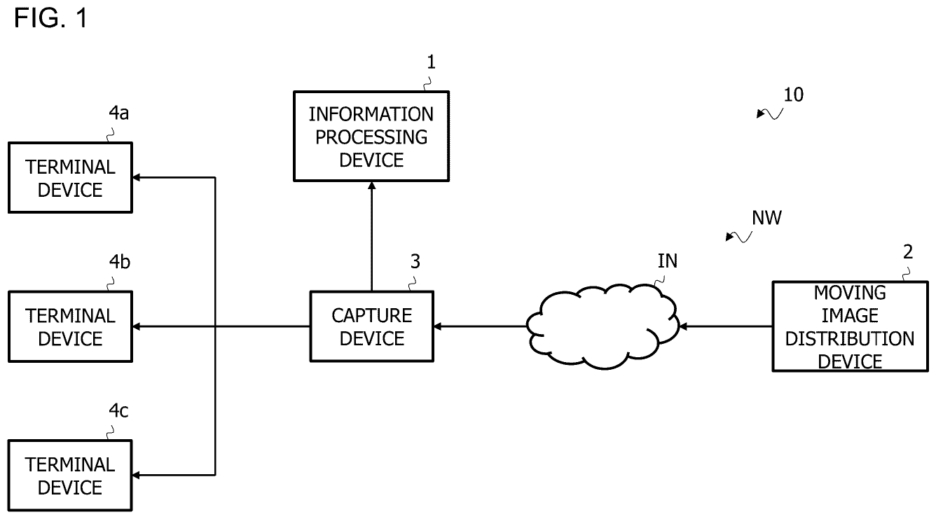

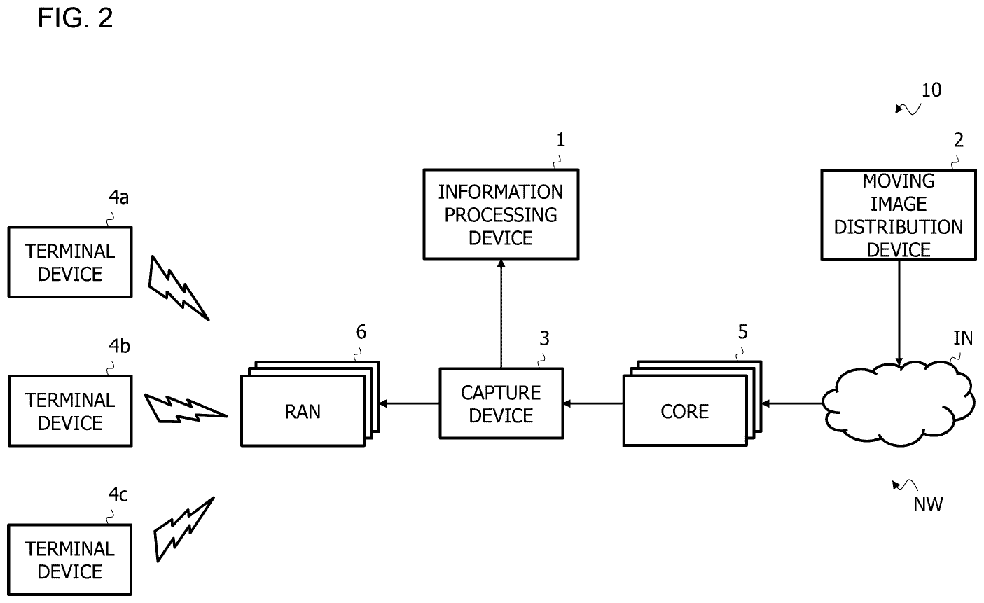

First, a configuration of an information processing system 10 will be described. FIGS. 1 and 2 are diagrams for illustrating configurations of the information processing system 10.

As depicted in FIG. 1, the information processing system 10 includes, for instance, an information processing device 1 (hereinafter also referred to as “network device 1”), a moving image distribution device 2 (hereinafter also referred to as “application device 2”), a capture device 3, a terminal device 4a, a terminal device 4b, and a terminal device 4c. Hereinafter, the terminal device 4a, the terminal device 4b, and the terminal device 4c will also be collectively referred to simply as “terminal devices 4”. Although a case where the information processing system 10 includes three terminal devices 4 will be described below, the number of terminal devices 4 included in the information processing system 10 may be other than three, for instance.

The moving image distribution device 2 may be, for instance, a physical machine or a virtual machine, and distributes moving image data over a network NW.

Each terminal device 4 may be, for instance, a terminal, e.g., a PC (personal computer) or a smart phone used by a user who watches moving image data (hereinafter also referred to simply as the “user”), and outputs the moving image data distributed from the moving image distribution device 2 over the network NW to an output screen (not depicted). Specifically, for instance, the terminal device 4 receives packets continuously transmitted from the moving image distribution device 2 over the network NW and outputs moving image data formed by the received packets to an output device.

The capture device 3, for instance, acquires packets transmitted from the moving image distribution device 2 to the terminal devices 4. Specifically, for instance, the capture device 3 duplicates packets transmitted from the moving image distribution device 2 to the terminal devices 4 and acquires the duplicated packets. Then, for instance, the capture device 3 transmits the acquired packets to the information processing device 1.

The network NW may be, for instance, a network that includes the Internet IN. Specifically, in the network NW, for instance, at least part of the connection between the moving image distribution device 2 and the terminal devices 4 is wired. In the network NW, for instance, part of the connection between the moving image distribution device 2 and the terminal devices 4 may be wireless. Note that the wireless communication here may comply with communications standards for the 5th Generation Mobile Communication System (5G), for instance.

More specifically, as depicted in FIG. 2, the network NW may include, for instance, a core network (CN) 5 and a radio access network 6. For instance, the core network 5 may be connected by wire to the Internet IN and the radio access network 6. For instance, the radio access network 6 may be connected wirelessly to each terminal device 4. Furthermore, for instance, the capture device 3 may be installed between the core network 5 and the radio access network 6.

Note that the following is a description of a case where, as depicted in FIGS. 1 and 2, the capture device 3 is disposed between the moving image distribution device 2 and the terminal devices 4 on the network NW, and the capture device 3 directly acquires packets transmitted from the moving image distribution device 2 to the terminal devices 4, but the present disclosure is not limited to this case. Specifically, for instance, packets transmitted from the moving image distribution device 2 to the terminal devices 4 may be acquired by a device, e.g., a TAP (Terminal Access Point) disposed between the moving image distribution device 2 and the terminal devices 4. Then, for instance, the capture device 3 may receive the packets transmitted from the device, e.g., the TAP, thereby acquiring the packets transmitted from the moving image distribution device 2 to the terminal devices 4.

The information processing device 1 may be, for instance, a physical machine or a virtual machine, and performs a process (hereinafter also referred to as “learning process”) of generating a learning model using teacher data generated based on packet acquisition statuses in the capture device 3.

Specifically, for instance, the information processing device 1 calculates, from the acquisition statuses of packets (hereinafter also referred to as “first packets”) transmitted from the moving image distribution device 2 to the terminal devices 4 over the network NW, group information (hereinafter also referred to as “first group information”) indicating the acquisition statuses for each of a plurality of groups (hereinafter also referred to as “packet groups”) each including a plurality of packets having a predetermined relationship with each other. The plurality of packets having a predetermined relationship with each other may be, for instance, a plurality of packets used to reproduce moving image data in the same time period (e.g., 10 seconds). Then, for instance, the information processing device 1 generates a learning model by learning teacher data including the first group information calculated, communication condition information (hereinafter also referred to as “first communication condition information”) indicating the communication conditions of the first packets in the network NW, and quality information (hereinafter also referred to as “first quality information”) indicating the quality in terms of the output of the first packets on the terminal devices 4. The communication condition information may be, for instance, a KPI (Key Performance Indicator), e.g., a delay time and a packet loss rate, with respect to transmission and reception of packets in the network NW. The quality information may be, for instance, QoE (Quality of Experience) on the terminal devices 4.

Also, for instance, the information processing device 1 performs a process (hereinafter, also referred to as “estimation process”) of estimating the quality information in the network NW by using a learning model generated in the learning process.

Specifically, as in the learning process, for instance, the information processing device 1 calculates, from the acquisition statuses of packets (hereinafter also referred to as “second packets”) transmitted from the moving image distribution device 2 to the terminal devices 4 over the network NW, group information (hereinafter also referred to as “second group information”) indicating the acquisition statuses of the packets for each of a plurality of packet groups. Then, for instance, the information processing device 1 acquires quality information (hereinafter also referred to as “second quality information”) output from the learning model as a result of input of the second group information calculated and communication condition information (hereinafter also referred to as “second communication condition information”) indicating the communication conditions of the second packets in the network NW. After that, for instance, the information processing device 1 outputs the acquired second quality information.

That is to say, for instance, when generating a learning model capable of estimating quality information, the information processing device 1 of the present embodiment performs learning using teacher data including not only the communication condition information and the quality information but also the group information indicating the packet acquisition statuses for each of a plurality of packet groups.

Thus, the information processing device 1 of the present embodiment is able to generate a learning model capable of estimating quality information, e.g., QoE with high accuracy even when, for instance, there is no sufficiently strong correlation between the timing at which a change in the communication condition information occurs in the network NW and the timing at which a change in the quality information occurs on a terminal device 4.

Note that the following is a description of a case where the learning process and the estimation process are performed in the same information processing device (information processing device 1), but the present disclosure is not limited this case. Specifically, the learning process and the estimation process may be performed in different information processing devices, for instance.

In addition, although the information processing system 10 in which the source of packets transmitted to the terminal devices 4 is the moving image distribution device 2 that distributes moving image data will be described below, the present disclosure is not limited to this. Specifically, the information processing system 10 may be an information processing system in which the source of packets transmitted to the terminal devices 4 is another information processing device that is not the moving image distribution device 2 (hereinafter also referred to simply as “the other information processing device”). More specifically, the information processing system 10 may be, for instance, a teleconferencing system that performs bidirectional communication of video data between the other information processing device and the terminal devices 4, or a voice communication system that performs bidirectional communication of voice data between the other information processing device and the terminal devices 4.

### Hardware Configuration of Information Processing Device

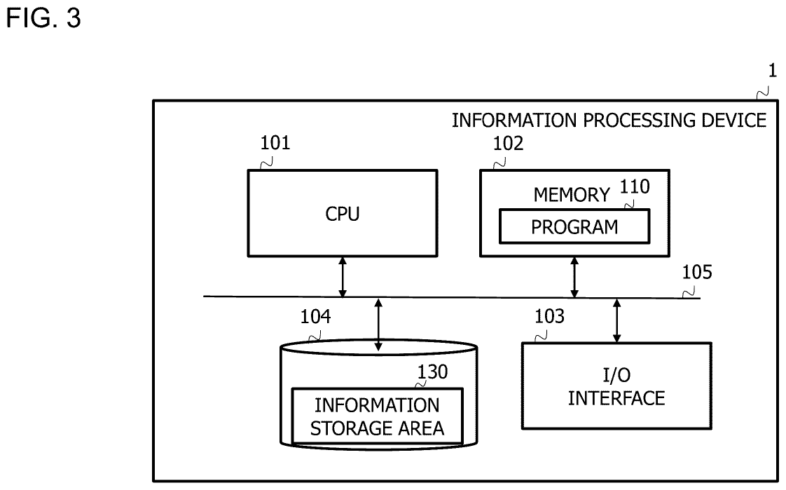

Next, a hardware configuration of an information processing device 1 will be described. FIG. 3 is a diagram for illustrating a hardware configuration of the information processing device 1.

As depicted in FIG. 3, the information processing device 1 includes, for instance, a CPU (central processing unit) 101, which is a processor, a memory 102, a communication device (I/O interface) 103, and a storage device 104. These units are connected to each other via a bus 105.

The storage device 104 has, for instance, a program storage area (not depicted) that stores a program 110 for performing the learning process and the estimation process. The storage device 104 also has, for instance, a storage unit 130 (hereinafter also referred to as “information storage area 130”) that stores information used in performing the learning process and the estimation process. The storage device 104 may be, for instance, an HDD (hard disk drive) or an SSD (solid state drive).

For instance, the CPU 101 performs the learning process and the estimation process by executing the program 110 loaded into the memory 102 from the storage device 104.

The communication device 103 communicates with the capture device 3, for instance.

### Functions of Information Processing Device according to First Embodiment

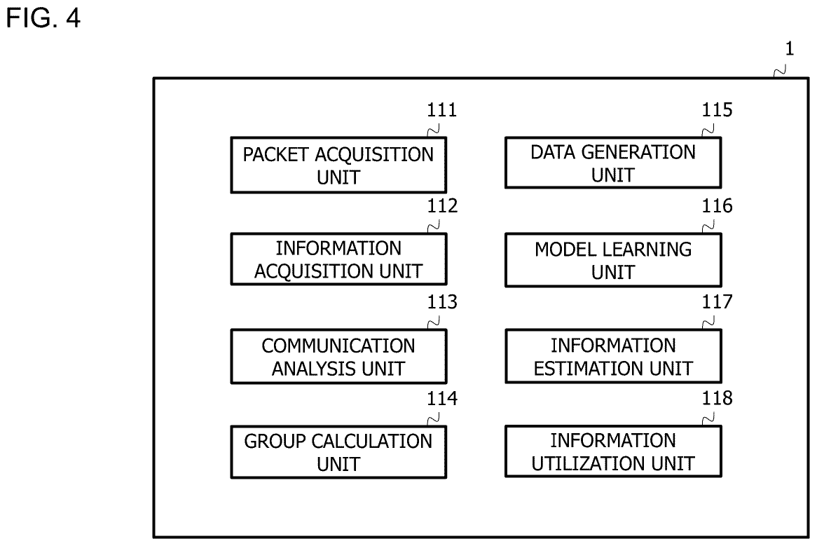

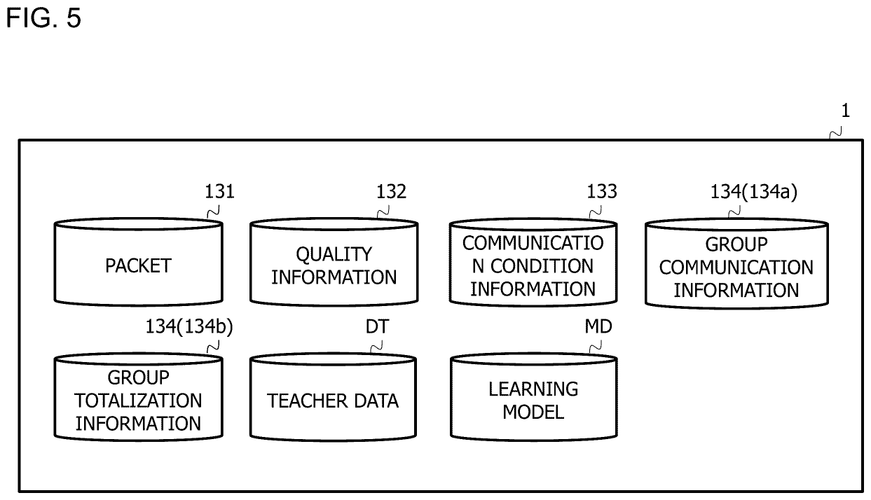

Next, functions of the information processing device 1 according to a first embodiment will be described. FIGS. 4 and 5 are diagrams for illustrating functions of the information processing device 1 according to the first embodiment.

As depicted in FIG. 4, for instance, the information processing device 1 realizes, due to its hardware components, e.g., the CPU 101 and the memory 102 organically cooperating with the program 110, various functions including a packet acquisition unit 111, an information acquisition unit 112, a communication analysis unit 113, a group calculation unit 114, a data generation unit 115, a model learning unit 116, an information estimation unit 117, and an information utilization unit 118.

In addition, as depicted in FIG. 5, for instance, the information storage area 130 stores packets 131, quality information 132, communication condition information 133, group information 134, teacher data DT, and a learning model MD. For instance, the group information 134 includes group communication information 134a indicating the acquisition statuses of packets 131 included in a plurality of packet groups, and group totalization information 134b indicating the results of totalization of the acquisition statuses of packets 131 for each of the plurality of packet groups.

Functions used in the learning process will be described first.

For instance, the packet acquisition unit 111 receives packets transmitted from the capture device 3 (packets captured by the capture device 3). Then, for instance, the packet acquisition unit 111 extracts packets 131 transmitted from the moving image distribution device 2 among the received packets. After that, for instance, the packet acquisition unit 111 stores the extracted packets 131 in the information storage area 130. Specifically, for instance, the packet acquisition unit 111 stores the acquired packets 131 in the information storage area 130 in a state in which terminal devices 4 to which packets 131 are transmitted, and sessions in which packets 131 are transmitted and received, are able to be identified.

More specifically, for instance, for each packet transmitted from the capture device 3, the packet acquisition unit 111 determines whether or not the packet is a packet 131 transmitted from the moving image distribution device 2, based on the combination of a source IP address contained in an IP (Internet Protocol) header of the packet and a source port number contained in a TCP (Transmission Control Protocol) header of the packet. Furthermore, for instance, for each packet 131 determined as being transmitted from the moving image distribution device 2, the packet acquisition unit 111 identifies a terminal device 4 that is the destination to which the packet 131 is transmitted and a session in which the packet 131 is transmitted and received, based on the combination of a destination IP address contained in the IP header of the packet 131 and a destination port contained in the TCP header of the packet 131. Then, for instance, the packet acquisition unit 111 stores the packets 131 determined as being transmitted from the moving image distribution device 2 in the information storage area 130, for each session for each terminal device 4.

The information acquisition unit 112, for instance, acquires quality information 132 regarding packets transmitted from the terminal devices 4, for each session for each terminal device 4. Specifically, for instance, the information acquisition unit 112 acquires quality information 132 input by users via their terminal devices 4. Then, for instance, the information acquisition unit 112 stores the acquired quality information 132 in the information storage area 130, for each session for each terminal device 4.

For instance, for each session for each terminal device 4, the communication analysis unit 113 generates communication condition information 133 from the acquisition statuses of packets 131 acquired by the packet acquisition unit 111. Then, for instance, the communication analysis unit 113 stores the generated communication condition information 133 in the information storage area 130, for each session for each terminal device 4.

Specifically, for instance, the communication analysis unit 113 may calculate, as the communication condition information 133, the amount of traffic per unit time, of packets 131 acquired by the packet acquisition unit 111, for each session for each terminal device 4.

In addition, for instance, the communication analysis unit 113 may calculate, for each session for each terminal device 4, the time (hereinafter also referred to as “needed response time”) between the timing at which a packet 131 transmitted from the moving image distribution device 2 has passed through the capture device 3 before being acquired by the packet acquisition unit 111 and the timing at which a reception acknowledgment (ACK: ACKnowledgement) transmitted from a terminal device 4 upon receiving that packet 131 has passed through the capture device 3. Then, for instance, the communication analysis unit 113 may calculate, as the communication condition information 133, the amount of time (hereinafter also referred to as “delay time”) obtained by subtracting a predetermined threshold value from the calculated needed response time, for each session for each terminal device 4.

In addition, for instance, the communication analysis unit 113 may calculate, for each session for each terminal device 4, the ratio (hereinafter also referred to as “packet loss rate”) of packets 131 for which no reception acknowledgment response has passed through the capture device 3 to packets 131 that have been transmitted from the moving image distribution device 2 and have passed through the capture device 3. For instance, the communication analysis unit 113 may calculate the above-described ratio as the communication condition information 133, for each session for each terminal device 4.

The group calculation unit 114, for instance, generates group communication information 134a from the acquisition statuses of packets 131 acquired by the packet acquisition unit 111, for each session for each terminal device 4. Then, for instance, the group calculation unit 114 stores the generated group communication information 134a in the information storage area 130, for each session for each terminal device 4.

In addition, for instance, for each of a plurality of packet groups, the group calculation unit 114 generates group totalization information 134b from the group communication information 134a corresponding to the packet group. Then, for instance, for each of the plurality of packet groups, the group calculation unit 114 stores the generated group totalization information 134b in the information storage area 130.

Specifically, for instance, when RTP (Real Time Transport Protocol) is used as the communication protocol, for each packet 131 received by the packet acquisition unit 111, the group calculation unit 114 refers to a time stamp contained in the RTP header of the packet 131. Then, for instance, the group calculation unit 114 classifies packets 131 into a plurality of packet groups such that one or more packets 131 with the same time stamp are included in the same packet group. Subsequently, for instance, for each of the plurality of packet groups, the group calculation unit 114 generates group totalization information 134b from the group communication information 134a corresponding to the packet group.

In addition, for instance, for each packet 131 received by the packet acquisition unit 111, the group calculation unit 114 identifies the reception time of the packet 131 (e.g., the time of day at which the packet is received by the packet acquisition unit 111), in the order in which packets 131 are received. Then, for instance, the group calculation unit 114 classifies packets 131 into a plurality of packet groups such that the boundary between packet groups is a point where the interval between the reception times of two packets 131 is greater than or equal to a predetermined threshold value. In other words, for instance, when the difference between the reception time of one packet 131 and the reception time of another packet 131 received immediately before the one packet 131 is less than the threshold value, the group calculation unit 114 determines that the one packet 131 and the other packet 131 received immediately before the one packet 131 are included in the same packet group. On the other hand, for instance, when the difference between the reception time of one packet 131 and the reception time of another packet 131 received immediately before the one packet 131 is greater than or equal to the threshold value, the group calculation unit 114 determines that the one packet 131 and the other packet 131 received immediately before the one packet 131 are included in different packet groups.

For instance, when TCP (Transmission Control Protocol) is used as the communication protocol, for each packet 131 received by the packet acquisition unit 111, the group calculation unit 114 refers to a PSH flag contained in the TCP header of the packet 131, in the order in which packets 131 are received. Then, for instance, the group calculation unit 114 classifies packets 131 into a plurality of packet groups such that the boundary between packet groups is a point between a packet 131 with a PSH flag “0” and a packet 131 received immediately after the packet 131 with the PSH flag “0”. In other words, for instance, when the PSH flag of a packet 131 is “1”, the group calculation unit 114 determines that this packet 131 and a packet 131 received immediately after this packet 131 are both included in the same packet group. On the other hand, for instance, when the PSH flag of a packet 131 is “0”, the group calculation unit 114 determines that this packet 131 and a packet 131 received immediately after this packet 131 are included in different packet groups.

In addition, for instance, for each packet 131 received by the packet acquisition unit 111, the group calculation unit 114 identifies the packet size of the packet 131, in the order in which packets 131 are received. Then, for instance, the group calculation unit 114 classifies packets 131 into a plurality of packet groups such that the boundary between packet groups is a point between a packet 131 whose packet size is a fraction (a number less than the maximum size of the packets 131) and a packet 131 received immediately after the packet 131 whose packet size is a fraction. In other words, for example, when the packet size of a packet 131 is not a fraction, the group calculation unit 114 determines that this packet 131 and a packet 131 received immediately after this packet 131 are both included in the same packet group. On the other hand, for instance, when the packet size of a packet 131 is a fraction, the group calculation unit 114 determines that this packet 131 and a packet 131 received immediately after this packet 131 are included in different packet groups.

The data generation unit 115, for instance, generates a plurality of sets of teacher data DT each including the quality information 132 acquired by the information acquisition unit 112, the communication condition information 133 generated by the communication analysis unit 113, and the group totalization information 134b calculated by the group calculation unit 114. Then, the data generation unit 115, for instance, stores the generated sets of teacher data DT in the information storage area 130.

Specifically, for instance, the data generation unit 115 generates a plurality of sets of teacher data DT such that the quality information 132, the communication condition information 133, and the group totalization information 134b corresponding to the same terminal device 4 and the same session and indicating conditions occurring at the same timing (in the same time period) are included in the same set of teacher data DT.

For instance, the model learning unit 116 generates a learning model MD by learning the plurality of sets of teacher data DT generated by the data generation unit 115. Then, for instance, the model learning unit 116 stores the generated learning model MD in the information storage area 130.

Next, functions used in the estimation process will be described.

For instance, the packet acquisition unit 111 extracts and acquires new packets 131 transmitted from the moving image distribution device 2, among new packets transmitted from the capture device 3. Then, for instance, the packet acquisition unit 111 stores the acquired new packets 131 in the information storage area 130, for each session for each terminal device 4.

The communication analysis unit 113, for instance, generates new communication condition information 133 from the acquisition statuses of the new packets 131 acquired by the packet acquisition unit 111, for each session for each terminal device 4. Then, for instance, the communication analysis unit 113 stores the generated new communication condition information 133 in the information storage area 130, for each session for each terminal device 4.

The group calculation unit 114, for instance, generates new group communication information 134a from the acquisition statuses of the new packets 131 acquired by the packet acquisition unit 111, for each session for each terminal device 4. Then, for instance, the group calculation unit 114 stores the generated new group communication information 134a in the information storage area 130, for each session for each terminal device 4.

Also, for instance, for each of a plurality of packet groups, the group calculation unit 114 generates new group totalization information 134b from the new group communication information 134a corresponding to the packet group. Then, for instance, for each of the plurality of packet groups, the group calculation unit 114 stores the generated new group totalization information 134b in the information storage area 130.

The information estimation unit 117, for instance, inputs, to the learning model MD, the new communication condition information 133 generated by the communication analysis unit 113 and the new group totalization information 134b calculated by the group calculation unit 114. Then, for instance, the information estimation unit 117 acquires new quality information 132 output from the learning model MD.

Specifically, for instance, the information estimation unit 117 inputs, to the learning model MD, the new communication condition information 133 and the new group totalization information 134b corresponding to the same terminal device 4 and the same session and indicating conditions occurring at the same timing.

The information utilization unit 118, for instance, controls network devices (not depicted) included in the information processing system 10, based on the new quality information 132 acquired by the information estimation unit 117.

Specifically, for instance, when the quality information 132 acquired by the information estimation unit 117 does not satisfy a predetermined quality requirement (hereinafter also referred to simply as “the quality requirement”), the information utilization unit 118 may change various settings of network devices (e.g., the radio access network 6 depicted in FIG. 2) included in the information processing system 10 so that the quality information 132 satisfies the quality requirement.

In addition, for instance, the information utilization unit 118 outputs the new quality information 132 acquired by the information estimation unit 117 to an operation terminal (not depicted) viewed by an administrator of the information processing device 1 (hereinafter also referred to simply as “the administrator”).

### Outline of Learning Process according to First Embodiment

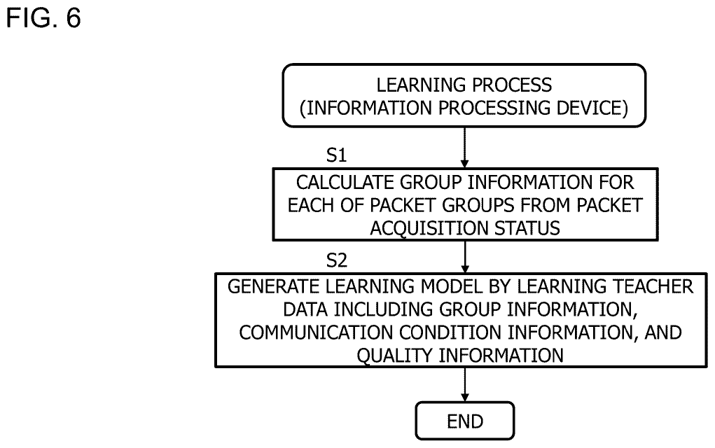

Next, an outline of the first embodiment will be described. FIG. 6 is a flowchart for illustrating an outline of the learning process according to the first embodiment.

As indicated in FIG. 6, for instance, the information processing device 1 calculates, based on the acquisition statuses of packets 131 transmitted from the moving image distribution device 2 to the terminal devices 4 over the network NW, group information 134 indicating the acquisition statuses of packets 131 for each of a plurality of packet groups (S1).

Then, for instance, the information processing device 1 generates a learning model MD by learning teacher data DT including the group information 134 calculated in the processing at S1, communication condition information 133 indicating communication conditions of the packets 131 in the network NW, and quality information 132 indicating the quality in terms of the output of the packets 131 on the terminal devices 4 (S2).

Thus, the information processing device 1 of the present embodiment is able to generate a learning model MD capable of estimating quality information 132, e.g., QoE with high accuracy even when, for instance, there is no sufficiently strong correlation between the timing at which a change in the communication condition information 133 occurs in the network NW and the timing at which a change in the quality information 132 occurs on a terminal device 4.

### Details of Learning Process according to First Embodiment

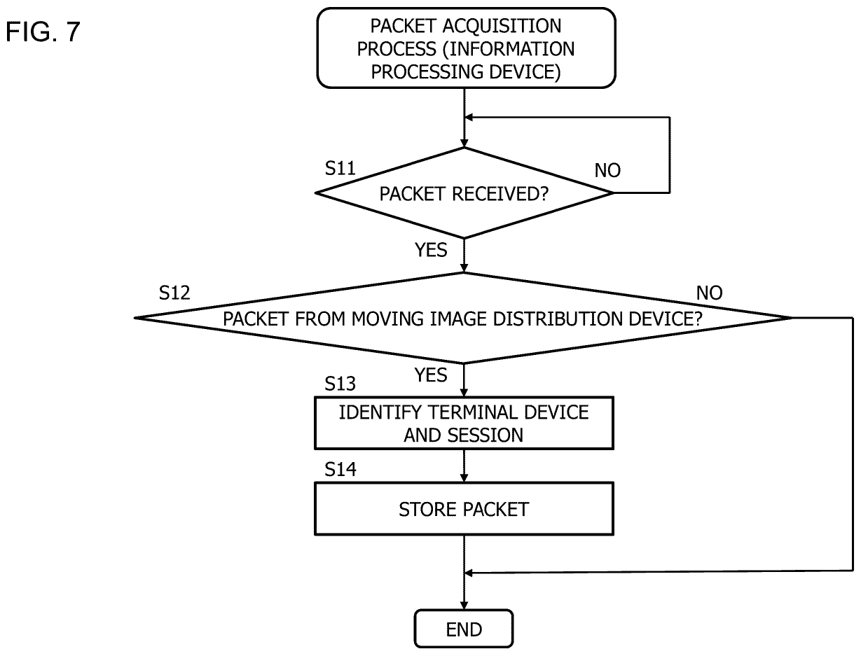

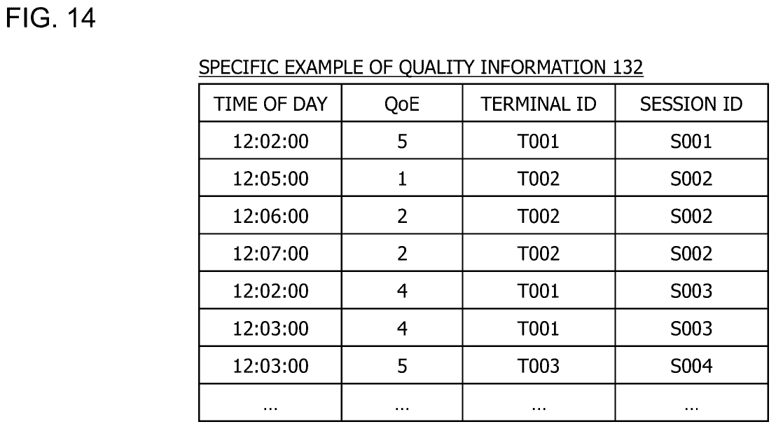

Next, details of the learning process according to the first embodiment will be described. FIGS. 7 to 13 are flowcharts for illustrating details of the learning process according to the first embodiment. Furthermore, FIGS. 14 to 22 are diagrams for illustrating details of the learning process according to the first embodiment.

### Packet Acquisition Process

First, a process (hereinafter also referred to as “packet acquisition process”) of acquiring packets 131 captured by the capture device 3, of the learning process will be described. FIG. 7 is a flowchart for illustrating the packet acquisition process.

As indicated in FIG. 7, for instance, the packet acquisition unit 111 waits until receiving a packet transmitted from the capture device 3 (NO at S11).

Then, when a packet transmitted from the capture device 3 is received (YES at S11), for instance, the packet acquisition unit 111 determines whether or not the received packet is a packet 131 transmitted from the moving image distribution device 2 (S12).

Specifically, for instance, the packet acquisition unit 111 determines whether or not the combination of the source IP address contained in the IP header of the packet received in the processing at S11 and the source port number contained in the TCP header of that packet received in the processing at S11 is the same as the combination of the IP address and the port number corresponding to the moving image distribution device 2.

As a result, when it is determined that the packet received in the processing at S11 is a packet 131 transmitted from the moving image distribution device 2 (YES at S12), for instance, the packet acquisition unit 111 identifies a terminal device 4 that is the destination to which the packet 131 received in the processing at S11 is transmitted and a session in which the packet 131 received in the processing at S11 is transmitted and received (S13).

Specifically, for instance, the packet acquisition unit 111 identifies a terminal device 4 and a session that correspond to the combination of the destination IP address contained in the IP header of the packet 131 received in the processing at S11 and the destination port number contained in the TCP header of that packet 131 received in the processing at S11.

Then, for instance, the packet acquisition unit 111 stores the packet 131 received in the processing at S11 in the information storage area 130 in association with identification information on the terminal device 4 and the session identified in the processing at S13 (S14).

On the other hand, when it is determined that the packet received in the processing at S11 is not a packet 131 transmitted from the moving image distribution device 2 (NO at S12), for instance, the packet acquisition unit 111 does not perform the processing at S13 and S14.

### Information Acquisition Process

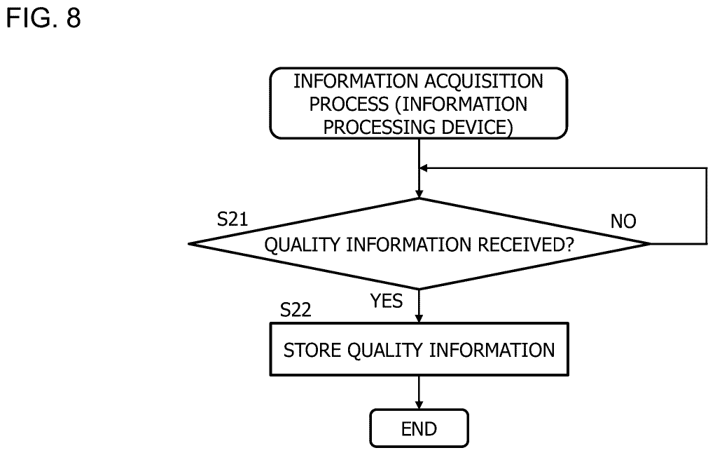

Next, a process (hereinafter also referred to as “information acquisition process”) of acquiring quality information 132, of the learning process will be described. FIG. 8 is a flowchart for illustrating the information acquisition process.

As indicated in FIG. 8, for instance, the information acquisition unit 112 waits until receiving quality information 132 transmitted from a terminal device 4 (NO at S21).

Specifically, for instance, the information acquisition unit 112 waits until a user enters, via a terminal device 4, quality information 132 for each session for each terminal device 4. Note that, for instance, the user inputs quality information 132 for each session for each terminal device 4, every predetermined period of time (e.g., every one minute).

Then, when the quality information 132 transmitted from the terminal device 4 is received (YES at S21), for instance, the information acquisition unit 112 stores the received quality information 132 in the information storage area 130 (S22).

Specifically, for instance, the information acquisition unit 112 stores the quality information 132 received in the processing at S21 in the information storage area 130 in association with identification information on the terminal device 4 from which, and also identification information on the session in which, the quality information 132 received in the processing at S21 is transmitted. A specific example of the quality information 132 will be described below.

### Specific Example of Quality Information

FIG. 14 is a diagram for illustrating a specific example of quality information 132. Specifically, FIG. 14 is a diagram for illustrating a specific example of quality information 132 accumulated in the information storage area 130.

The quality information 132 indicated in FIG. 14 includes, for instance, fields with field names “TIME” in which times of day are set, “QoE” in which QoE values at respective times of day are set, “TERMINAL ID” in which pieces of identification information on terminal devices 4 corresponding to respective QoE values are set, and “SESSION ID” in which pieces of identification information on sessions corresponding to respective QoE values are set. In the “QoE” fields, for instance, “5”, “4”, “3”, “2”, or “1” is set, in descending order of quality.

Specifically, as a set of information in the first row of the quality information 132 indicated in FIG. 14, for instance, “12:02:00” is set in “TIME”, “5” is set in “QoE”, “T001” is set in “TERMINAL ID”, and “S001” is set in “SESSION ID”.

This means that the set of information in the first row of the quality information 132 indicated in FIG. 14 indicates that, for instance, among QoE values corresponding to the session with the session ID S001 of the terminal device 4 with the terminal ID T001, the QoE value at the time point 12:02:00 is 5.

Also, as a set of information on the second row of the quality information 132 indicated in FIG. 14, for instance, “12:05:00” is set in “TIME”, “1” is set in “QoE”, “T002” is set in “TERMINAL ID”, and “S002” is set in “SESSION ID”.

This means that the set of information in the second row of the quality information 132 indicated in FIG. 14 indicates that, for instance, among QoE values corresponding to the session with the session ID S002 of the terminal device 4 with the terminal ID T002, the QoE value at the time point 12:05:00 is 1. Descriptions of the other sets of information in FIG. 14 are omitted.

### First Information Generation Process

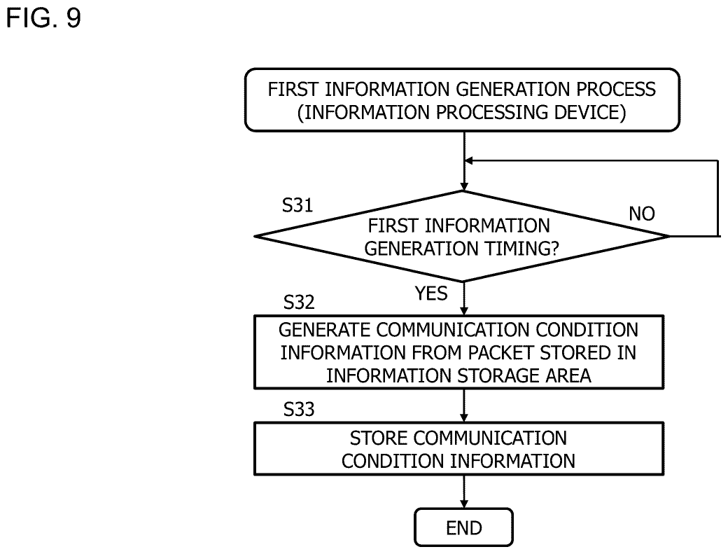

Next, a process (hereinafter also referred to as “first information generation process”) of generating communication condition information 133 of the learning process will be described. FIG. 9 is a flowchart for illustrating the first information generation process.

As indicated in FIG. 9, for instance, the communication analysis unit 113 waits until a first information generation timing (NO at S31). The first information generation timing may be periodic, e.g., every minute, for instance.

Then, at the first information generation timing (YES at S31), for instance, the communication analysis unit 113 generates communication condition information 133 by using, from among packets 131 stored in the information storage area 130, packets 131 transmitted from the capture device 3 during a period from the previous first information generation timing (e.g., one minute ago) to the current first information generation timing (S32).

After that, for instance, the communication analysis unit 113 stores the communication condition information 133 generated in the processing at S32 in the information storage area 130 (S33). A specific example of the communication condition information 133 will be described below.

### Specific Example of Communication Condition Information

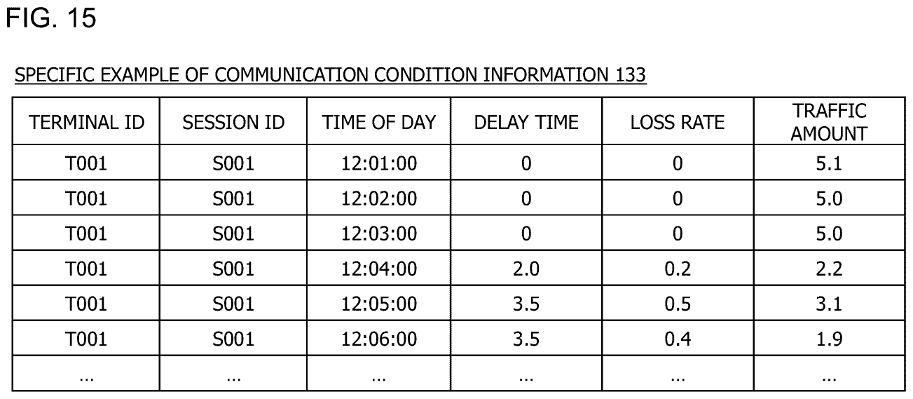

FIG. 15 is a diagram for illustrating a specific example of communication condition information 133. Specifically, FIG. 15 is a diagram for illustrating a specific example of communication condition information 133 accumulated in the information storage area 130.

The communication condition information 133 indicated in FIG. 15 includes, for instance, fields with field names “TERMINAL ID” in which pieces of identification information on respective terminal devices 4 are set, “SESSION ID” in which pieces of identification information on respective sessions are set, “TIME” in which times of day are set, “DELAY TIME” in which a delay time of transmission and reception of packets 131 at respective times of day is set, “LOSS RATE” in which packet loss rates of packets 131 at respective times of day are set, and “TRAFFIC AMOUNT” in which the amounts of traffic at respective times of day are set.

Specifically, as a set of information in the first row of the communication condition information 133 indicated in FIG. 15, for instance, “T001” is set in “TERMINAL ID”, “S001” is set in “SESSION ID”, “12:01:00” is set in “TIME”, “0 (ms)” is set in “DELAY TIME”, “0 (%)” is set in “LOSS RATE”, and “5.1 (Mbps)” is set in “TRAFFIC AMOUNT”.

Also, as a set of information in the fourth row of the communication condition information 133 indicated in FIG. 15, for instance, “T001” is set in “TERMINAL ID”, “S001” is set in “SESSION ID”, “12:04:00” is set in “TIME”, “2.0 (ms)” is set in “DELAY TIME”, “0.2 (%)” is set in “LOSS RATE”, and “2.2 (Mbps)” is set in “TRAFFIC AMOUNT”. Descriptions of the other sets of information in FIG. 15 are omitted.

### Second Information Generation Process

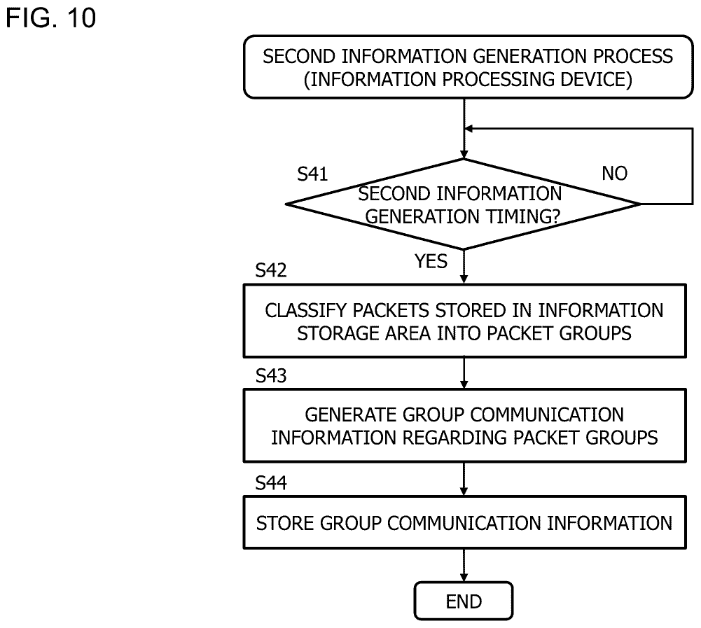

Next, a process (hereinafter also referred to as “second information generation process”) of generating group communication information 134a, of the learning process will be described. FIG. 10 is a flowchart for illustrating the second information generation process.

As indicated in FIG. 10, for instance, the group calculation unit 114 waits until a second information generation timing (NO at S41). The second information generation timing may be periodic, e.g., every minute, for instance. Specifically, the second information generation timing may be the same timing as the first information generation timing, for instance.

Then, at the second information generation timing (YES at S41), for instance, the group calculation unit 114 classifies, from among packets 131 stored in the information storage area 130, packets 131 transmitted from the capture device 3 during a period from the previous second information generation timing (e.g., one minute ago) to the current second information generation timing into a plurality of packet groups (S42).

Specifically, for instance, when RTP is used as the communication protocol, for each packet 131 received by the packet acquisition unit 111, the group calculation unit 114 refers to the time stamp contained in the RTP header of the packet 131, in the order in which packets 131 are received. Then, for instance, the group calculation unit 114 identifies packets 131 with the same time stamp as packets 131 included in the same packet group. Hereinafter, the process of classifying packets 131 into a plurality of packet groups using the time stamps of the packets 131 will also be referred to as “first classification process”.

In addition, for instance, for each packet 131 received by the packet acquisition unit 111, the group calculation unit 114 identifies the reception time of the packet 131 (e.g., the time of day at which the packet is received by the packet acquisition unit 111), in the order in which packets 131 are received. Then, for instance, the group calculation unit 114 identifies, as the boundary between packet groups, a point where the interval between the reception times of two packets 131 is longer than a threshold value. Hereinafter, the process of classifying packets 131 into a plurality of packet groups using the reception times of the packets 131 will also be referred to as “second classification process”.

In addition, for instance, when TCP is used as the communication protocol, for each packet 131 received by the packet acquisition unit 111, the group calculation unit 114 refers to the PSH flag contained in the TCP header of the packet 131, in the order in which packets 131 are received. Then, the group calculation unit 114 identifies, as the boundary between packet groups, a point between a packet 131 with a PSH flag “0” and a packet 131 received immediately after the packet 131 with the PSH flag “0”. Hereinafter, the process of classifying packets 131 into a plurality of packet groups using the PSH flags of the packets 131 will also be referred to as “third classification process”.

In addition, for instance, for each packet 131 received by the packet acquisition unit 111, the group calculation unit 114 identifies the packet size of the packet 131, in the order in which packets 131 are received. Then, for instance, the group calculation unit 114 identifies, as the boundary between packet groups, a point between a packet 131 whose packet size is a fraction (a number less than the maximum size of the packets) and a packet 131 received immediately after the packet 131 whose packet size is a fraction. Hereinafter, the process of classifying packets 131 into a plurality of packet groups using the packet sizes of the packets 131 will also be referred to as “fourth classification process”.

Subsequently, for instance, the group calculation unit 114 generates group communication information 134a for each of the packet groups into which the packets 131 have been classified in the processing at S42 (S43).

After that, for instance, the group calculation unit 114 stores the group communication information 134a generated in the processing at S43 in the information storage area 130 (S44).

Note that, for instance, the second information generation timing may be the timing at which the packet acquisition unit 111 receives a packet 131 in the processing at S11. In other words, for instance, the group calculation unit 114 may generate, in response to the reception of a packet 131 by the packet acquisition unit 111 in the processing at S11, group communication information 134a regarding the received packet 131. A specific example of the group communication information 134a will be described below.

### Specific Example of Group Communication Information

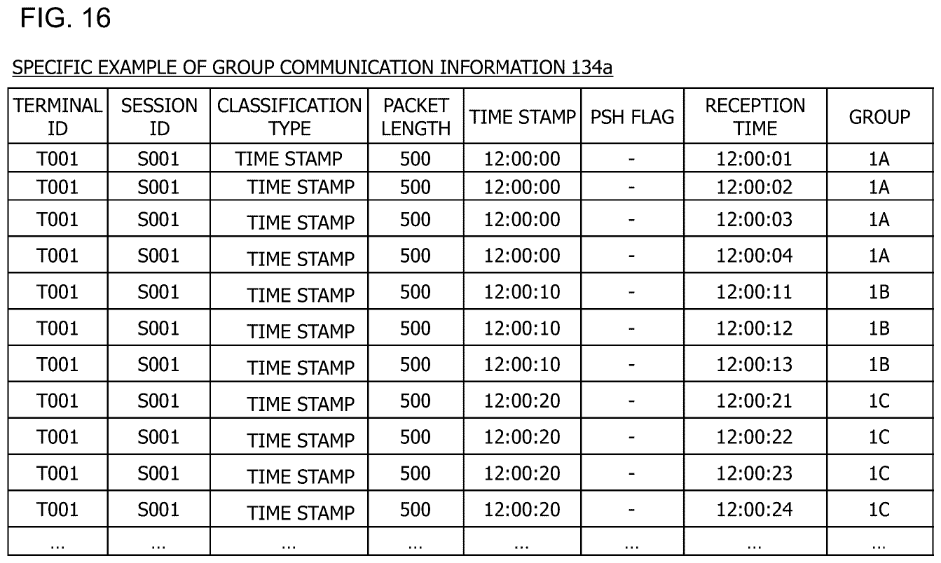

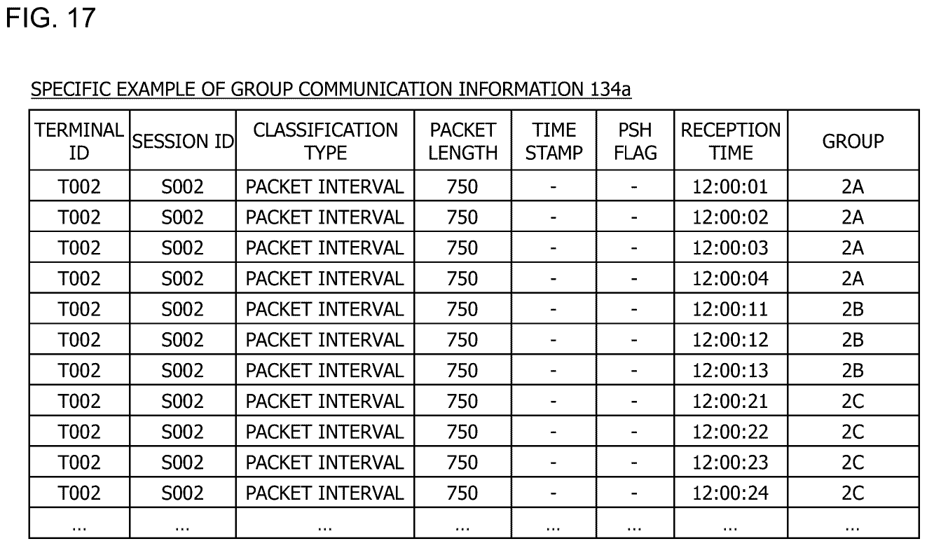

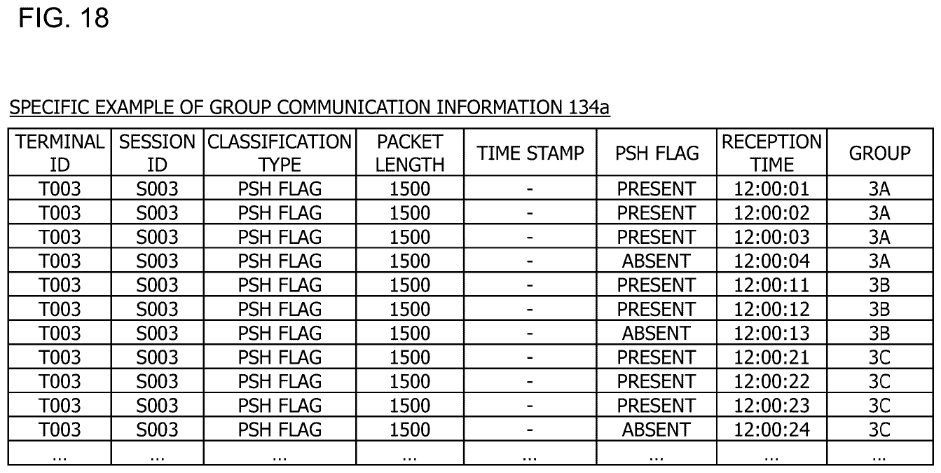

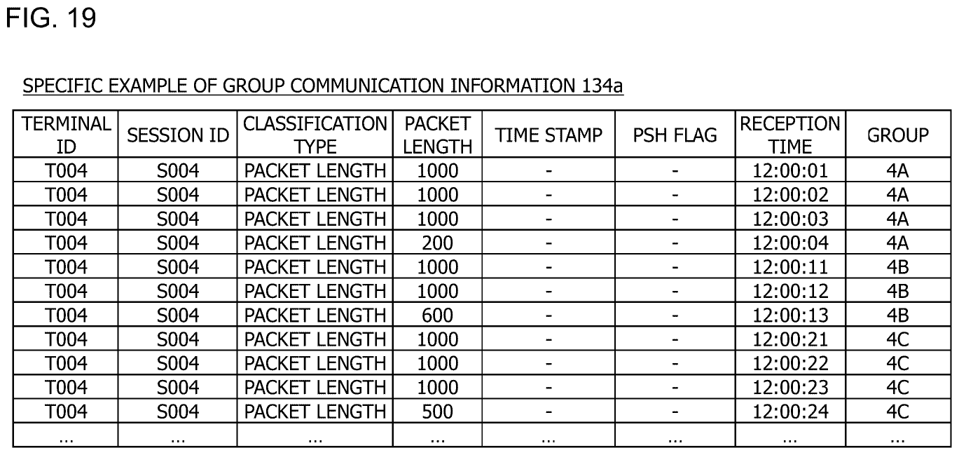

FIGS. 16 to 19 are diagrams for illustrating specific examples of group communication information 134a. Specifically, FIG. 16 is a diagram for illustrating a specific example of the group communication information 134a in the case where the first classification process is performed in the processing at S42. FIG. 17 is a diagram for illustrating a specific example of the group communication information 134a in the case where the second classification process is performed in the processing at S42. FIG. 18 is a diagram for illustrating a specific example of the group communication information 134a in the case where the third classification process is performed in the processing at S42. FIG. 19 is a diagram for illustrating a specific example of the group communication information 134a in the case where the fourth classification process is performed in the processing at S42.

The group communication information 134a indicated in FIG. 16 and the like includes, for instance, fields with field names “TERMINAL ID” in which pieces of identification information on respective terminal devices 4 are set, “SESSION ID” in which pieces of identification information on respective sessions are set, and “CLASSIFICATION TYPE” in which pieces of identification information on respective classification processes performed in the processing at S42 are set. In the “CLASSIFICATION TYPE” fields, for instance, “TIME STAMP” indicating the first classification process, “PACKET INTERVAL” indicating the second classification process, “PSH FLAG” indicating the third classification process, or “PACKET LENGTH” indicating the fourth classification process is set. In addition, the group communication information 134a indicated in FIG. 16 and the like includes, for instance, fields with field names “PACKET LENGTH” in which the packet lengths (packet sizes) of respective packets 131 are set, “TIME STAMP” in which the times of day at which respective packets 131 are generated in the moving image distribution device 2 are set, and “PSH FLAG” in which the PSH flags of respective packets 131 are set. In addition, the group communication information 134a indicated in FIG. 16 and the like includes, for instance, “RECEPTION TIME” in which the times of day at which respective packets 131 are received by the information processing device 1 are set and “GROUP” in which pieces of identification information on packet groups including packets 131 are set. Note that, in the following description, it is assumed that “-” is set in a field in which no information is set.

### Specific Example of Group Communication Information when First Classification Process is Performed

First, group communication information 134a in the case where the first classification process is performed in the processing at S42 will be described.

For instance, as a set of information in the first row of the group communication information 134a indicated in FIG. 16, “T001” is set in “TERMINAL ID”, “S001” is set in “SESSION ID”, “TIME STAMP” is set in “CLASSIFICATION TYPE”, “500 (bytes)” is set in “PACKET LENGTH”, “12:00:00” is set in “TIME STAMP”, “-” is set in “PSH FLAG”, “12:00:01” is set in “RECEPTION TIME”, and “1A” is set in “GROUP”.

For instance, as a set of information in the second row of the group communication information 134a indicated in FIG. 16, “T001” is set in “TERMINAL ID”, “S001” is set in “SESSION ID”, “TIME STAMP” is set in “CLASSIFICATION TYPE”, “500 (bytes)” is set in “PACKET LENGTH”, “12:00:00” is set in “TIME STAMP”, “-” is set in “PSH FLAG”, “12:00:02” is set in “RECEPTION TIME”, and “1A” is set in “GROUP”.

For instance, as a set of information in the fifth row of the group communication information 134a indicated in FIG. 16, “T001” is set in “TERMINAL ID”, “S001” is set in “SESSION ID”, “TIME STAMP” is set in “CLASSIFICATION TYPE”, “500 (bytes)” is set in “PACKET LENGTH”, “12:00:10” is set in “TIME STAMP”, “-” is set in “PSH FLAG”, “12:00:11” is set in “RECEPTION TIME”, and “1B” is set in “GROUP”. Descriptions of the other sets of information in FIG. 16 are omitted.

That is to say, for instance, in the “TIME STAMP” fields of the sets of information in the first to fourth rows of the group communication information 134a indicated in FIG. 16, the same time of day (12:00:00) is set. Therefore, as indicated in FIG. 16, for instance, the group calculation unit 114 sets “1A”, which is information indicating the same packet group, in the “GROUP” fields of the sets of information in the first to fourth rows.

Also, for instance, in the “TIME STAMP” fields of the sets of information in the fifth to seventh rows of the group communication information 134a indicated in FIG. 16, the same time of day (12:00:10) is set. Therefore, as indicated in FIG. 16, for instance, the group calculation unit 114 sets “1B”, which is information indicating the same packet group, in the “GROUP” fields of the sets of information in the fifth to seventh rows.

### Specific Example of Group Communication Information when Second Classification Process is Performed

Next, group communication information 134a in the case where the second classification process is performed in the processing at S42 will be described.

For instance, as a set of information in the first row of the group communication information 134a indicated in FIG. 17, “T002” is set in “TERMINAL ID”, “S002” is set in “SESSION ID”, “PACKET INTERVAL” is set in “CLASSIFICATION TYPE”, “750 (bytes)” is set in “PACKET LENGTH”, “-” is set in “TIME STAMP”, “-” is set in “PSH FLAG”, “12:00:01” is set in “RECEPTION TIME”, and “2A” is set in “GROUP”.

For instance, as a set of information in the fourth row of the group communication information 134a indicated in FIG. 17, “T002” is set in “TERMINAL ID”, “S002” is set in “SESSION ID”, “PACKET INTERVAL” is set in “CLASSIFICATION TYPE”, “750 (bytes)” is set in “PACKET LENGTH”, “-” is set in “TIME STAMP”, “-” is set in “PSH FLAG”, “12:00:04” is set in “RECEPTION TIME”, and “2A” is set in “GROUP”.

For instance, as a set of information in the fifth row of the group communication information 134a indicated in FIG. 17, “T002” is set in “TERMINAL ID”, “S002” is set in “SESSION ID”, “PACKET INTERVAL” is set in “CLASSIFICATION TYPE”, “750 (bytes)” is set in “PACKET LENGTH”, “-” is set in “TIME STAMP”, “-” is set in “PSH FLAG”, “12:00:11” is set in “RECEPTION TIME”, and “2B” is set in “GROUP”. Descriptions of the other sets of information in FIG. 17 are omitted.

That is to say, in the group communication information 134a indicated in FIG. 17, for instance, the interval between “RECEPTION TIME” of the set of information in the fourth row and “RECEPTION TIME” of the set of the information in the fifth row is 7 (seconds). Therefore, for instance, when the interval of 7 (seconds) between “RECEPTION TIME” of the set of information in the fourth row and “RECEPTION TIME” of the set of the information in the fifth row is greater than or equal to a predetermined threshold value, the group calculation unit 114 sets “2A”, which is information indicating the same packet group, in the “GROUP” fields of the sets of information in the first to fourth rows, as indicated in FIG. 17.

Also, in the group communication information 134a indicated in FIG. 17, for instance, the interval between “RECEPTION TIME” of the set of information in the seventh row and “RECEPTION TIME” of the set of the information in the eighth row is 8(seconds). Therefore, for instance, when the interval of 8 (seconds) between “RECEPTION TIME” of the set of information in the seventh row and “RECEPTION TIME” of the set of the information in the eighth row is greater than or equal to the predetermined threshold value, the group calculation unit 114 sets “2B”, which is information indicating the same packet group, in the “GROUP” fields of the sets of information in the fifth to seventh rows, as indicated in FIG. 17.

### Specific Example of Group Communication Information when Third Classification Process is Performed

Next, group communication information 134a in the case where the third classification process is performed in the processing at S42 will be described.

For instance, as a set of information in the first row of the group communication information 134a indicated in FIG. 18, “T003” is set in “TERMINAL ID”, “S003” is set in “SESSION ID”, “PSH FLAG” is set in “CLASSIFICATION TYPE”, “1500 (bytes)” is set in “PACKET LENGTH”, “-” is set in “TIME STAMP”, “PRESENT” is set in “PSH FLAG”, “12:00:01” is set in “RECEPTION TIME”, and “3A” is set in “GROUP”.

For instance, as a set of information in the fourth row of the group communication information 134a indicated in FIG. 18, “T003” is set in “TERMINAL ID”, “S003” is set in “SESSION ID”, “PSH FLAG” is set in “CLASSIFICATION TYPE”, “1500 (bytes)” is set in “PACKET LENGTH”, “-” is set in “TIME STAMP”, “ABSENT” is set in “PSH FLAG”, “12:00:04” is set in “RECEPTION TIME”, and “3A” is set in “GROUP”.

For instance, as a set of information in the fifth row of the group communication information 134a indicated in FIG. 18, “T003” is set in “TERMINAL ID”, “S003” is set in “SESSION ID”, “PSH FLAG” is set in “CLASSIFICATION TYPE”, “1500 (bytes)” is set in “PACKET LENGTH”, “-” is set in “TIME STAMP”, “PRESENT” is set in “PSH FLAG”, “12:00:11” is set in “RECEPTION TIME”, and “3B” is set in “GROUP”. Descriptions of the other sets of information in FIG. 18 are omitted.

That is to say, in the group communication information 134a indicated in FIG. 18, for instance, “PRESENT” is set in the “PSH FLAG” fields of the sets of information in the first to third rows, and “ABSENT” is set in the “PSH FLAG” field of the set of information in the fourth row. Therefore, as indicated in FIG. 18, for instance, the group calculation unit 114 sets “3A”, which is information indicating the same packet group, in the “GROUP” fields of the sets of information in the first to fourth rows.

Also, in the group communication information 134a indicated in FIG. 18, for instance, “PRESENT” is set in the “PSH FLAG” fields of the sets of information in the fifth and sixth rows, and “ABSENT” is set in the “PSH FLAG” field of the set of information in the seventh row. Therefore, as indicated in FIG. 18, for instance, the group calculation unit 114 sets “3B”, which is information indicating the same packet group, in the “GROUP” fields of the sets of information in the fifth to seventh rows.

### Specific Example of Group Communication Information when Fourth Classification Process is Performed

Next, group communication information 134a in the case where the fourth classification process is performed in the processing at S42 will be described.

For instance, as a set of information in the first row of the group communication information 134a indicated in FIG. 19, “T004” is set in “TERMINAL ID”, “S004” is set in “SESSION ID”, “PACKET LENGTH” is set in “CLASSIFICATION TYPE”, “1000 (bytes)” is set in “PACKET LENGTH”, “-” is set in “TIME STAMP”, “-” is set in “PSH FLAG”, “12:00:01” is set in “RECEPTION TIME”, and “4A” is set in “GROUP”.

For instance, as a set of information in the fourth row of the group communication information 134a indicated in FIG. 19, “T004” is set in “TERMINAL ID”, “S004” is set in “SESSION ID”, “PACKET LENGTH” is set in “CLASSIFICATION TYPE” “200 (bytes)” is set in “PACKET LENGTH”, “-” is set in “TIME STAMP”, “-” is set in “PSH FLAG”, “12:00:04” is set in “RECEPTION TIME”, and “4A” is set in “GROUP”.

For instance, as a set of information in the fifth row of the group communication information 134a indicated in FIG. 19, “T004” is set in “TERMINAL ID”, “S004” is set in “SESSION ID”, “PACKET LENGTH” is set in “CLASSIFICATION TYPE”, “1000 (bytes)” is set in “PACKET LENGTH”, “-” is set in “TIME STAMP”, “-” is set in “PSH FLAG”, “12:00:11” is set in “RECEPTION TIME”, and “4B” is set in “GROUP”. Descriptions of the other sets of information in FIG. 19 are omitted.

That is to say, in the group communication information 134a indicated in FIG. 19, for instance, “1000 (bytes)” is set in the “PACKET LENGTH” fields of the sets of information in the first to third rows, and “200 (bytes)” is set in the “PACKET LENGTH” field of the set of information in the fourth row. Therefore, as indicated in FIG. 19, for instance, the group calculation unit 114 sets “4A”, which is information indicating the same packet group, in the “GROUP” fields of the sets of information in the first to fourth rows.

Also, in the group communication information 134a indicated in FIG. 19, for instance, “1000 (bytes)” is set in the “PACKET LENGTH” fields of the sets of information in the fifth and sixth rows, and “200 (bytes)” is set in the “PACKET LENGTH” field of the set of information in the seventh row. Therefore, as indicated in FIG. 19, for instance, the group calculation unit 114 sets “4B”, which is information indicating the same packet group, in the “GROUP” fields of the sets of information in the fifth to seventh rows.

### Third Information Generation Process

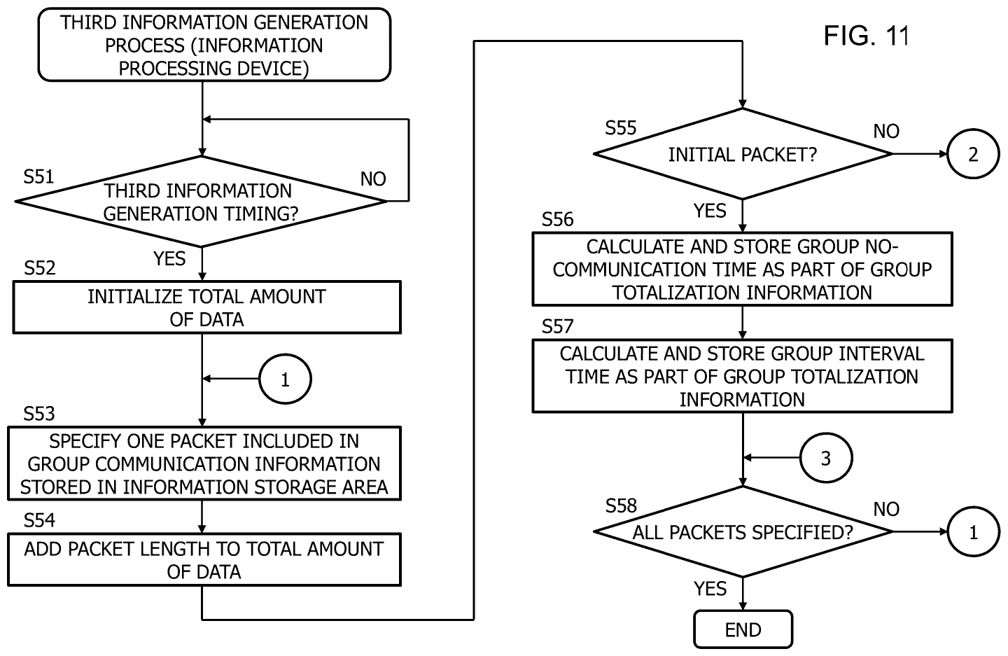

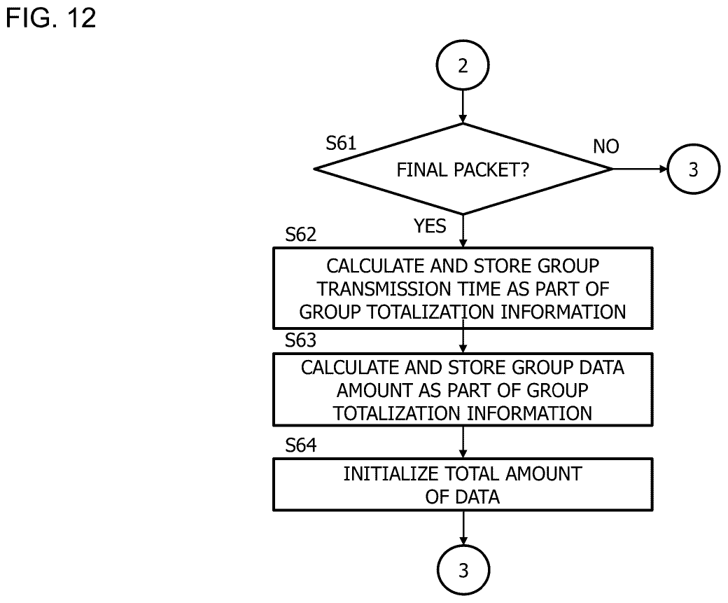

Next, a process (hereinafter also referred to as “third information generation process”) of generating group totalization information 134b, of the learning process will be described. FIGS. 11 and 12 are flowcharts for illustrating the third information generation process. Note that, in the following description, it is assumed that the group communication information 134a generated in the second information generation process is the group communication information 134a that has been described using FIG. 16.

As indicated in FIG. 11, for instance, the group calculation unit 114 waits until a third information generation timing (NO at S51). The third information generation timing may be periodic, e.g., every minute, for instance. Specifically, the third information generation timing may be immediately after the second information generation timing, for instance.

Then, at the third information generation timing (YES at S51), for instance, the group calculation unit 114 initializes the total amount of data stored in the information storage area 130 (S52). Specifically, for instance, the group calculation unit 114 sets 0 (bytes) as the total amount of data stored in the information storage area 130.

Then, for instance, the group calculation unit 114 specifies a single set of information included in the group communication information 134a stored in the information storage area 130 (S53).

Specifically, for instance, when the processing at S53 is performed for the first time, the group calculation unit 114 specifies the set of information in the first row of the group communication information 134a that has been described using FIG. 16.

Subsequently, for instance, the group calculation unit 114 adds the packet length included in the set of information specified in the processing at S53 to the total amount of data (S54).

Specifically, “500 (bytes)” is set in “PACKET LENGTH” of the set of information in the first raw of the group communication information 134a that has been described using FIG. 16. Therefore, for instance, when the information specified in the processing at S53 is the set of information in the first row of the group communication information 134a that has been described using FIG. 16, the group calculation unit 114 adds “500 (bytes)” to the value indicated by the total amount of data stored in the information storage area 130.

Next, for instance, the group calculation unit 114 determines whether or not a packet 131 indicated by the set of information specified in the processing at S53 is the first packet 131 (hereinafter also referred to as “initial packet 131”) in a packet group (S55).

Specifically, for instance, the group calculation unit 114 refers to the group communication information 134a stored in the information storage area 130, and compares the times of day set in the “RECEPTION TIME” fields of respective sets of information in which the pieces of information set in the “GROUP” fields are the same as that of the set of information specified in the processing at S53. Then, for instance, the group calculation unit 114 determines whether or not the time of day set in “RECEPTION TIME” of the set of information specified in the processing at S53 is the earliest time of day among the compared times of day.

As a result, when it is determined that the packet 131 indicated by the set of information specified in the processing at S53 is an initial packet 131 (YES at S55), for instance, the group calculation unit 114 calculates a group no-communication time corresponding to the packet 131 indicated by the set of information specified in the processing at S53, and stores the calculated group no-communication time, as part of group totalization information 134b, in the information storage area 130 (S56). The group no-communication time is, for instance, a period of time between the reception time of a packet 131 received immediately before the packet 131 indicated by the set of information specified in the processing at S53 and the reception time of the packet 131 indicated by the set of information specified in the processing at S53. In other words, the group no-communication time is, for instance, a period of time between the reception time of the last packet 131 (hereinafter also referred to as “final packet 131”) of a packet group received immediately before a packet group including the packet 131 indicated by the set of information specified in the processing at S53 and the reception time of the initial packet 131 included in the packet group including the packet 131 indicated by the set of information specified in the processing at S53.

In addition, in this case, for instance, the group calculation unit 114 calculates a group interval time corresponding to the packet 131 indicated by the set of information specified in the processing at S53, and stores the calculated group interval time, as part of the group totalization information 134b, in the information storage area 130 (S57). The group interval time is, for instance, a period of time between the reception time of an initial packet 131 of the packet group received immediately before the packet group including the packet 131 indicated by the set of information specified in the processing at S53 and the reception time of the packet 131 indicated by the set of information specified in the processing at S53. In other words, the group interval time is, for instance, a period of time between the reception time of the initial packet 131 of the packet group received immediately before the packet group including the packet 131 indicated by the set of information specified in the processing at S53 and the reception time of the initial packet 131 of the packet group including the packet 131 indicated by the set of information specified in the processing at S53.

On the other hand, in the processing at S55, when it is determined that the packet 131 indicated by the set of information specified in the processing at S53 is not an initial packet 131 (NO at S55), for instance, the group calculation unit 114 determines whether or not the packet 131 indicated by the set of information specified in the processing at S53 is a final packet 131 included in a packet group, as indicated in FIG. 12 (S61).

Specifically, for instance, the group calculation unit 114 refers to the group communication information 134a stored in the information storage area 130, and compares the times of day set in the “RECEPTION TIME” fields of respective sets of information in which the pieces of information set in the “GROUP” fields are the same as that of the set of information specified in the processing at S53. Then, for instance, the group calculation unit 114 determines whether or not the time of day set in the “RECEPTION TIME” of the set of information specified in the processing at S53 is the latest time of day among the compared times of day.

As a result, when it is determined that the packet 131 indicated by the set of information specified in the processing at S53 is a final packet 131 (YES at S61), for instance, the group calculation unit 114 calculates a group transmission time corresponding to the packet 131 indicated by the set of information specified in the processing at S53, and stores the calculated group transmission time, as part of the group totalization information 134b, in the information storage area 130 (S62). The group transmission time is, for instance, a period of time between the reception time of an initial packet 131 of the packet group including the packet 131 indicated by the set of information specified in the processing at S53 and the reception time of the packet 131 indicated by the set of information specified in the processing at S53. In other words, the group transmission time is, for example, a period of time between the reception time of the initial packet 131 of the packet group including the packet 131 indicated by the set of information specified in the processing at S53 and the reception time of the final packet 131 of the packet group including the packet 131 indicated by the set of information specified in the processing at S53.

Also, in this case, for instance, the group calculation unit 114 stores the total amount of data stored in the information storage area 130, as part of the group totalization information 134b, in the information storage area 130 (S63).

After that, for instance, the group calculation unit 114 initializes the total amount of data stored in the information storage area 130 (S64). Specifically, for instance, the group calculation unit 114 sets 0 (bytes) as the total amount of data stored in the information storage area 130.

On the other hand, when it is determined that the packet 131 indicated by the set of information specified in the processing at S53 is not a final packet 131 (NO at S61), for instance, the group calculation unit 114 does not perform the processing at S62 to S64.

Then, for instance, the group calculation unit 114 determines whether or not all the sets of information have been specified in the processing at S53 (S58). Note that, for instance, the group calculation unit 114 performs the processing at S58 after the processing at S57 as well.

As a result, when it is determined that all the sets of information have not yet been specified in the processing at S53 (NO at S58), for instance, the group calculation unit 114 performs the processing at S53 and thereafter again.

On the other hand, when it is determined that all the sets of information have been specified in the processing at S53 (YES at S58), for instance, the group calculation unit 114 ends the third information generation process. A specific example of the third information generation process will be described below.

### Specific Example of Third Information Generation Process

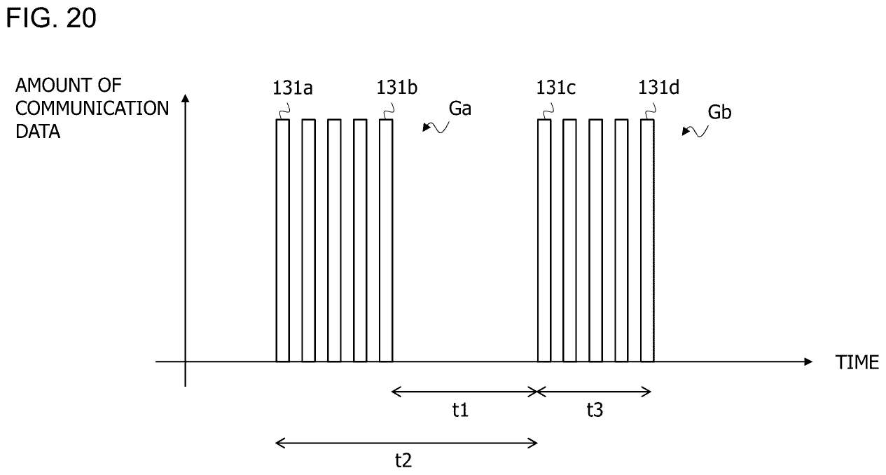

FIG. 20 is a diagram for illustrating a specific example of the third information generation process. Note that the horizontal axis of the graph indicated in FIG. 20 corresponds to time. The vertical axis of the graph indicated in FIG. 20 corresponds to the amount of communication data (packet length of packet 131) in the network NW.

Specifically, in the example indicated in FIG. 20, for instance, a packet group Ga and a packet group Gb received immediately after the packet group Ga are indicated.

Then, for instance, when a packet 131 corresponding to the set of information specified in the processing at S53 is an initial packet 131 (hereinafter also referred to as “packet 131c”) included in the packet group Gb, the group calculation unit 114 calculates, as the group no-communication time, a time period t1 between the reception time of a final packet 131 (hereinafter referred to as “packet 131b”) included in the packet group Ga and the reception time of the packet 131c (S56).

In addition, for instance, when the packet 131 corresponding to the set of information specified in the processing at S53 is the packet 131c, the group calculation unit 114 calculates, as the group interval time a time period t2 between the reception time of an initial packet 131 (hereinafter referred to as “packet 131a”) included in the packet group Ga and the reception time of the packet 131c (S57).

Alternatively, for instance, when the packet 131 corresponding to the set of information specified in the processing at S53 is a final packet 131 (hereinafter also referred to as “packet 131d”) included in the packet group Gb, the group calculation unit 114 calculates, as the group interval time, a time period t3 between the reception time of the packet 131c and the reception time of the packet 131d as the group transmission time (S62).

### Specific Example of Group Totalization Information

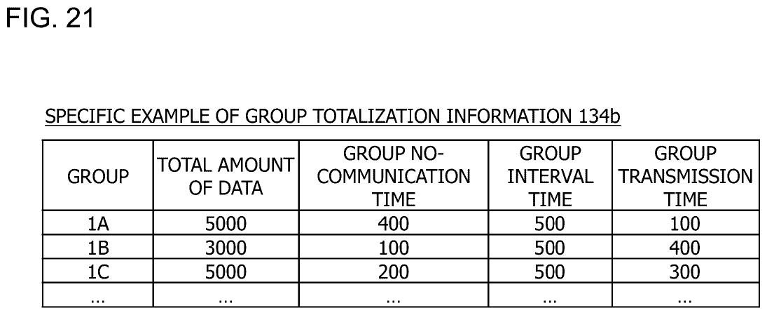

Next, a specific example of the group totalization information 134b will be described. FIG. 21 is a diagram for illustrating a specific example of the group totalization information 134b.

The group totalization information 134b indicated in FIG. 21 includes, for instance, fields with field names “GROUP” in which pieces of identification information on respective packet groups are set, “TOTAL DATA AMOUNT” in which the total amounts of data corresponding to respective packet groups are set, “GROUP NO-COMMUNICATION TIME” in which the values of group no-communication time corresponding to respective packet groups are set, “GROUP INTERVAL TIME” in which the values of group interval time corresponding to respective packet groups are set, and “GROUP TRANSMISSION TIME” in which the values of group transmission time corresponding to respective packet groups are set.

Specifically, for instance, in the first row of the group totalization information 134b indicated in FIG. 21, “1A” is set in “GROUP”, “5000 (bytes)” is set in “TOTAL DATA AMOUNT”, “400 (ms)” is set in “GROUP NO-COMMUNICATION TIME”, “500 (ms)” is set in “GROUP INTERVAL TIME”, and “100 (ms)” is set in “GROUP TRANSMISSION TIME”.

Also, for instance, in the second row of the group totalization information 134b indicated in FIG. 21, “1B” is set in “GROUP”, “3000 (bytes)” is set in “TOTAL DATA AMOUNT”, “100 (ms)” is set in “GROUP NO-COMMUNICATION TIME”, “500 (ms)” is set in “GROUP INTERVAL TIME”, and “400 (ms)” is set in “GROUP TRANSMISSION TIME”. Descriptions of the other sets of information in FIG. 21 are omitted.

### Main Process of Learning Process

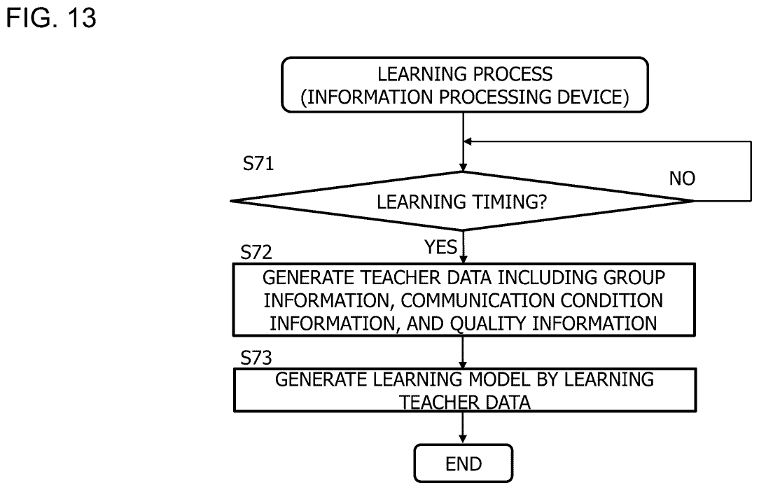

Next, a main process of the learning process (hereinafter also referred to simply as “main process”) will be described. FIG. 13 is a flowchart for illustrating the main process.

As indicated in FIG. 13, for instance, the data generation unit 115 waits until a learning timing (NO at S71). The learning timing may be, for instance, a timing at which information to instruct the generation of a learning model MD is input to the information processing device 1 by the administrator.

Then, at the learning timing (YES at S71), for instance, the data generation unit 115 generates a plurality of sets of teacher data DT each including the quality information 132, the communication condition information 133, and the group totalization information 134b stored in the information storage area 130 (S72). After that, for instance, the data generation unit 115 stores the generated plurality of sets of teacher data DT in the information storage area 130.

Specifically, for instance, the data generation unit 115 generates a plurality of sets of teacher data DT such that quality information 132, communication condition information 133, and group information 134 that correspond to the same terminal device 4 and the same session and are generated at the same timing are included in the same set of teacher data DT. A specific example of a plurality of sets of teacher data DT will be described below.

### Specific Example of Teacher Data

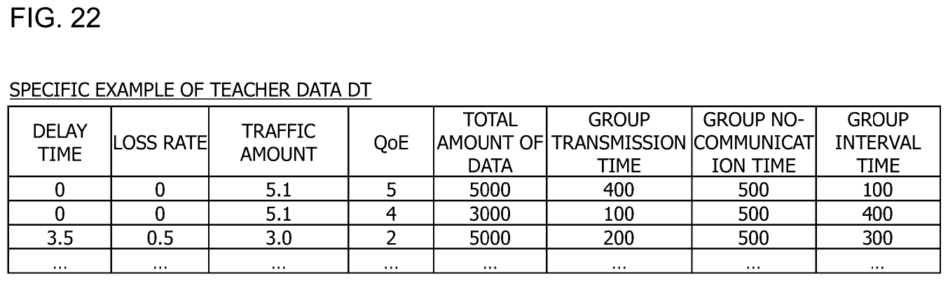

FIG. 22 is a diagram for illustrating a specific example of a plurality of sets of teacher data DT. Specifically, FIG. 22 is a diagram for illustrating a specific example of a plurality of sets of teacher data DT accumulated in the information storage area 130.

Each set of teacher data DT indicated in FIG. 22 includes, for instance, fields with field names “DELAY TIME” in which the delay time of transmission and reception of packets 131 is set, “LOSS RATE” in which the loss rate of packets 131 are set, “TRAFFIC AMOUNT” in which the traffic amount of packets 131 is set, and “QoE” in which the QoE value of a relevant terminal device 4 is set. Also, each set of teacher data DT indicated in FIG. 22 includes, for instance, fields with field names “TOTAL DATA AMOUNT” in which the total amount of data corresponding to a packet group is set, “GROUP NO-COMMUNICATION TIME” in which the value of group no-communication time corresponding to the packet group is set, “GROUP INTERVAL TIME” in which the value of group interval time corresponding to the packet group is set, and “GROUP TRANSMISSION TIME” in which the value of group transmission time corresponding to the packet group is set.

Specifically, as a set of information in the first row of the teacher data DT indicated in FIG. 22, for instance, “0 (ms)” is set in “DELAY TIME”, “0 (%)” is set in “LOSS RATE”, “5.1 (Mbps)” is set in “TRAFFIC AMOUNT”, and “5” is set in “QoE”. In addition, for instance, as the set of information in the first row of the teacher data DT indicated in FIG. 22, “5000 (bytes)” is set in “TOTAL DATA AMOUNT”, “400 (ms)” is set in “GROUP NO-COMMUNICATION TIME”, “500 (ms)” is set in “GROUP INTERVAL TIME”, and “100 (ms)” is set in “GROUP TRANSMISSION TIME”.

Also, as a set of information in the third row of the teacher data DT indicated in FIG. 22, for instance, “3.5 (ms)” is set in “DELAY TIME”, “0.5 (%)” is set in “LOSS RATE”, “3.0 (Mbps)” is set in “TRAFFIC AMOUNT”, and “2” is set in “QoE”. In addition, for instance, as the set of information in the third row of the teacher data DT indicated in FIG. 22, “5000 (bytes)” is set in “TOTAL DATA AMOUNT”, “200 (ms)” is set in “GROUP NO-COMMUNICATION TIME”, “500 (ms)” is set in “GROUP INTERVAL TIME”, and “300 (ms)” is set in “GROUP TRANSMISSION TIME”. Descriptions of the other sets of data in FIG. 22 are omitted.

Referring again to FIG. 13, for instance, the model learning unit 116 generates a learning model MD by learning the plurality of sets of teacher data DT generated in the processing at S72 (S73). Then, for instance, the model learning unit 116 stores the generated learning model MD in the information storage area 130.

### Estimation Process according to First Embodiment

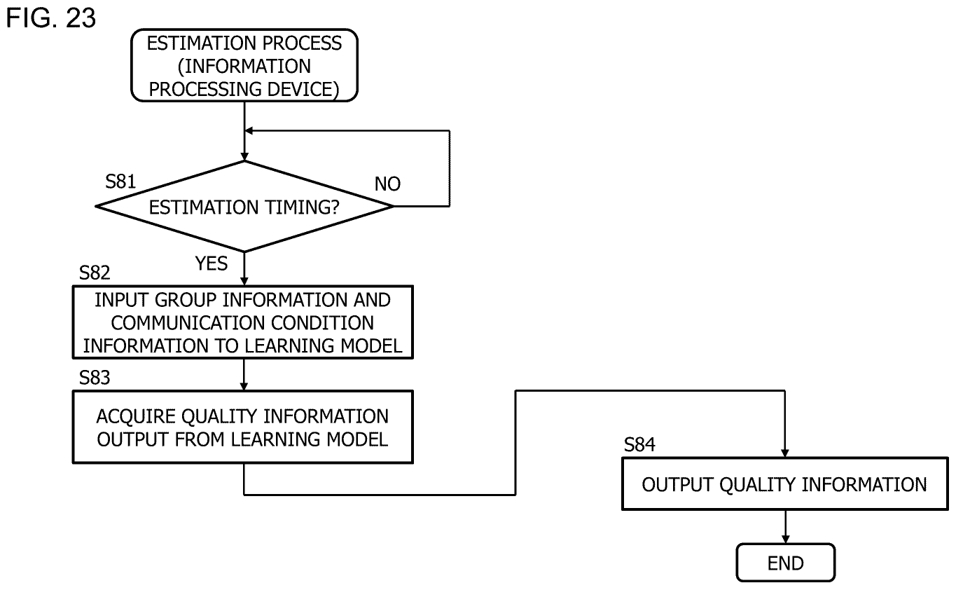

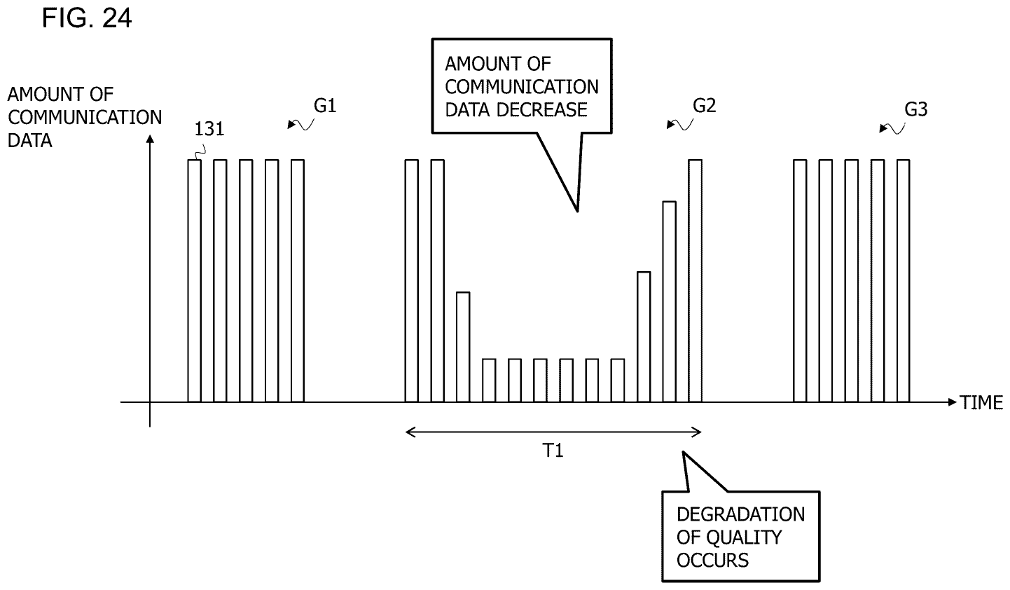

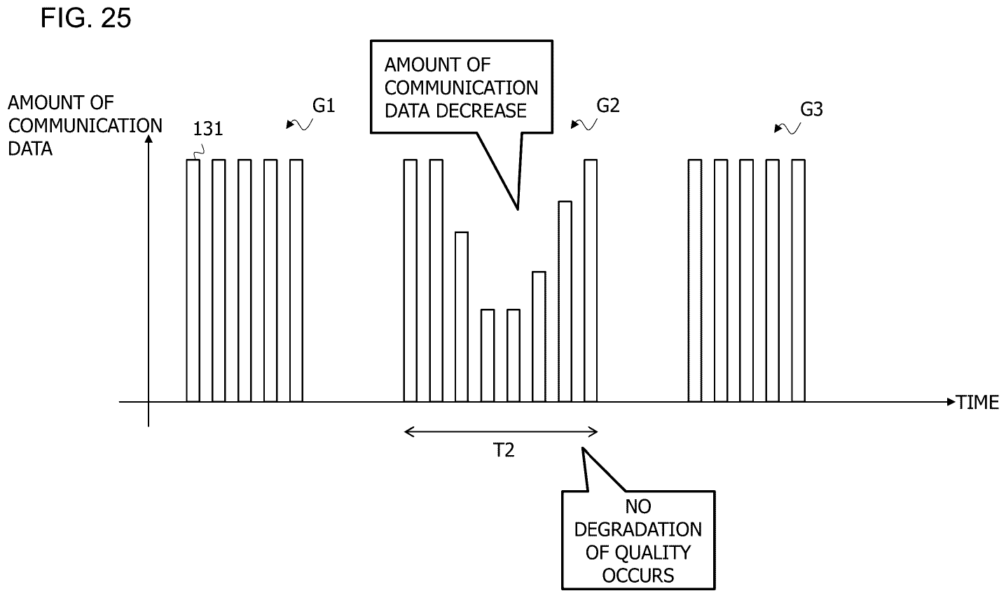

Next, the estimation process according to the first embodiment will be described. FIG. 23 is a flowchart for illustrating the estimation process according to the first embodiment. Also, FIGS. 24 and 25 are diagrams for illustrating the estimation process according to the first embodiment.

As indicated in FIG. 23, for instance, the information estimation unit 117 waits until an estimation timing (NO at S81). The estimation timing may be, for instance, a timing at which information to instruct the estimation of quality information 132 is input to the information processing device 1 by the administrator.

Then, at the estimation timing (YES at S81), for instance, the information estimation unit 117 inputs, to the learning model MD, communication condition information 133 stored in the information storage area 130 and group totalization information 134b stored in the information storage area 130 (S82).

Specifically, for instance, the information estimation unit 117 acquires communication condition information 133 corresponding to the timing for estimating the quality information 132, from the communication condition information 133 stored in the information storage area 130. In addition, for instance, the information estimation unit 117 acquires group totalization information 134b corresponding to the timing for estimating the quality information 132, from the group totalization information 134b stored in the information storage area 130. Then, for instance, the information estimation unit 117 inputs the acquired communication condition information 133 and the acquired group totalization information 134b to the learning model MD.

More specifically, for instance, the information estimation unit 117 acquires the latest set of communication condition information 133, from the communication condition information 133 stored in the information storage area 130. Also, for instance, the information estimation unit 117 acquires the latest set of group totalization information 134b, from the group totalization information 134b stored in the information storage area 130. Then, for instance, the information estimation unit 117 inputs the acquired sets of communication condition information 133 and group totalization information 134b to the learning model MD.

After that, for instance, the information estimation unit 117 acquires quality information 132 output from the learning model MD (S83).

Then, for instance, the information utilization unit 118 outputs the quality information 132 acquired in the processing at S83 to an operation terminal (not depicted) (S84).

Furthermore, in this case, for instance, the information utilization unit 118 controls network devices (not depicted) included in the information processing system 10, based on the quality information 132 acquired in the processing at S83.

As described above, in the learning process, for instance, the information processing device 1 of the present embodiment calculates, from the acquisition statuses of first packets 131 transmitted from the moving image distribution device 2 to terminal devices 4 over the network NW, first group information 134 indicating the acquisition statuses of the first packets 131 for each of a plurality of packet groups. Then, for instance, the information processing device 1 generates a learning model MD by learning teacher data DT including the first group information 134 calculated, first communication condition information 133 indicating the communication conditions of the first packets 131 in the network NW, and first quality information 132 indicating the quality in terms of the output of the first packets 131 on the terminal devices 4.

In the estimation process, for instance, the information processing device 1 calculates, from the acquisition statuses of second packets 131 transmitted from the moving image distribution device 2 to terminal devices 4 over the network NW, second group information 134 indicating the acquisition statuses of the second packets 131 (hereinafter also referred to as “other packets 131”) for each of a plurality of packet groups. Then, for instance, the information processing device 1 acquires second quality information 132 output from the learning model MD as a result of the input of the second group information 134 calculated and second communication condition information 133 indicating the communication conditions of the second packets 131 in the network NW. Then, for instance, the information processing device 1 outputs the acquired second quality information 132.

In other words, for instance, when generating a learning model MD capable of estimating quality information 132, the information processing device 1 of the present embodiment performs learning using teacher data DT including not only the communication condition information 133 and the quality information 132 but also the group information 134 indicating the acquisition statuses of packets 131 for each of a plurality of packet groups.

Thus, the information processing device 1 of the present embodiment is able to generate a learning model MD capable of estimating quality information 132, e.g., QoE with high accuracy even when, for instance, there is no sufficiently strong correlation (there is a weak correlation) between the timing at which a change in the communication condition information 133 occurs in the network NW and the timing at which a change in the quality information 132 occurs on a terminal device 4.

Accordingly, the administrator is able to take an appropriate action, e.g., controlling a network device for enhancing the quality information 132 on the terminal device 4, by referring to the estimation result of the quality information 132 on the terminal device 4, for instance.

Specifically, as indicated in FIG. 24, for instance, when a decrease in the amount of communication data occurs in a network NW while a packet group G2 is being transmitted during a time period between a packet group G1 and a packet group G3, resulting in an increase in the transmission time T1 of the packet group G2, reproduction of the moving image data on a terminal device 4 may be interrupted. In this case, for instance, degradation of QoE and the like occurs on the terminal device 4.

In contrast, as indicated in FIG. 25, for instance, even when a decrease in the amount of communication data occurs in the network NW while the packet group G2 is being transmitted, when the transmission time T2 of the packet group G2 is shorter than the transmission time T1, and transmission of all packets 131 included in the packet group G2 is completed before reproduction of the moving image data on a terminal device 4 is interrupted, interruption of the reproduction of the moving image data on the terminal device 4 may be prevented. In this case, for instance, no degradation of QoE and the occurs on the terminal device 4.

That is to say, the correlation between the communication condition information 133 and the quality information 132 at the timing for transmitting the packet group G2 varies depending on, for instance, the transmission time (e.g., the group transmission time that has been described using FIG. 21) of the packet group G2. Therefore, it is able to be concluded that the correlation between the communication condition information 133 and the quality information 132 at the timing for transmitting the packet group G2 is not necessarily strong.

For this reason, for instance, the information processing device 1 of the present embodiment generates a learning model MD by learning teacher data DT including not only the communication condition information 133 and the quality information 132 but also the group information 134, and thereby also using information regarding whether or not any deterioration of the communication condition occurring in the network NW has actually affected the reproduction of moving image data on a terminal device 4. This enables the information processing device 1 of the present embodiment to, for instance, generate a learning model MD capable of estimating quality information 132, e.g., QoE with high accuracy.

In addition, for instance, the information processing device 1 of the present embodiment refers to data contained in headers (e.g., RTP headers or TCP headers) of packets 131 transmitted from the moving image distribution device 2, thereby generating group information 134 corresponding to the respective packets 131.

This enables the information processing device 1 of the present embodiment to, for instance, generate group information 134 corresponding to the respective packets 131 without the need to perform analysis or the like of data contained in portions other than the headers, of the data contained in the packets 131. Also, this enables the information processing device 1 to, for instance, generate group information 134 corresponding to the respective packets 131 even when portions (data contained in portions other than the headers) of the data contained in the packets 131 are encrypted in order to enhance the security, for instance.

Note that, in the foregoing examples, a case where a learning model MD is generated by using teacher data DT including quality information 132, communication condition information 133, and group information 134 at the same timing has been described, but the present disclosure is not limited to this case. Specifically, for instance, the information processing device 1 may generate a learning model MD by using teacher data DT including communication condition information 133 and group information 134 at the same timing (hereinafter also referred to as “first timing”) and quality information 132 at a second timing later than the first timing.

Thus, in the estimation process, for instance, the information processing device 1 is able to estimate quality information 132 (i.e., future quality information 132) at a timing later than the timing corresponding to the communication condition information 133 and the group information 134 that are input to the learning model MD.

Furthermore, in the foregoing examples, a case where the information processing device 1 (packet acquisition unit 111) acquires packets 131 transmitted from the capture device 3, and the information processing device 1 (communication analysis unit 113) generates communication condition information 133 from the packets 131 has been described, but the present disclosure is not limited to this case.

Specifically, for instance, the communication condition information 133 may be generated by the capture device 3 that has acquired the packets 131. In addition, for instance, the information processing device 1 (information acquisition unit 112) may receive the communication condition information 133 transmitted from the capture device 3 and store the received communication condition information 133 in the information storage area 130.

This eliminates the need for the information processing device 1 to have a storage area (information storage area 130) capable of storing packets 131 transmitted from the capture device 3, for instance, and enables therefore reduction in operational costs.

According to an aspect, quality information is able to be estimated with high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network device comprising:
a memory; and
a processor coupled to the memory and the processor configured to:
calculate, based on acquisition statuses of packets in a capture device that acquires the packets transmitted from an application device to a terminal device over a network, first group information indicating the acquisition statuses for each of a plurality of packet groups each including a plurality of packets having a predetermined relationship with each other; and
generate a learning model by learning teacher data including the first group information calculated, first communication condition information indicating communication conditions of the packets in the network, and first quality information indicating quality in terms of output of the packets on the terminal device.

2. The network device according to claim 1, wherein
the packets are packets constituting moving image data that is distributed from the application device to the terminal device and reproduced on the terminal device, and
the first quality information is information indicating QoE (Quality of Experience) of the moving image data on the terminal device.

3. The network device according to claim 2, wherein
the plurality of packets having the predetermined relationship with each other are a plurality of packets used to reproduce the moving image data in a same time period.

4. The network device according to claim 1, wherein
the processor acquires the packets transmitted from the capture device, and
the processor calculates the first group information based on the acquisition statuses of the packets.

5. The network device according to claim 4, wherein
the processor calculates the first communication condition information based on the acquisition statuses of the packets.

6. The network device according to claim 1, wherein
the capture device generates the first communication condition information based on the acquisition statuses of the packets in the capture device,
the processor acquires the first communication condition information transmitted from the capture device.

7. The network device according to claim 1, wherein
for each of the packet groups, the processor generates, as at least one piece of the first group information, information indicating a time difference between a reception timing of a packet received first among the packets included in the packet group and a reception timing of a packet received last among the packets included in the packet group.

8. The network device according to claim 1, wherein
for each of the packet groups, the processor generates, as at least one piece of the first group information, information indicating a time difference between a reception timing of a packet received first among the packets included in the packet group and a reception timing of a packet received last among the packets included in a packet group transmitted immediately before the packet group.

9. The network device according to claim 1, wherein
for each of the packet groups, the processor generates, as at least one piece of the first group information, information indicating a time difference between a reception timing of a packet received first among the packets included in the packet group and a reception timing of a packet received first among the packets included a packet group transmitted immediately before the packet group.

10. The network device according to claim 1, wherein
for each of the packet groups, the processor generates, as at least one piece of the first group information, a total amount of data of the packets included in the packet group.

11. The network device according to claim 1, wherein
the processor calculates, based on the acquisition statuses of other packets transmitted from the application device to the terminal device over the network, second group information indicating the acquisition statuses for each of a plurality of packet groups,
the processor acquires second quality information output from the learning model as a result of input of the second group information calculated and second communication condition information indicating communication conditions of the other packets in the network; and
the processor outputs the acquired second quality information.

12. A model learning method comprising:
calculating, by a processor, based on acquisition statuses of packets in a capture device that acquires the packets transmitted from an application device to a terminal device over a network, first group information indicating the acquisition statuses for each of a plurality of packet groups each including a plurality of packets having a predetermined relationship with each other; and
generating, by the processor, a learning model by learning teacher data including the first group information calculated, first communication condition information indicating communication conditions of the packets in the network, and first quality information indicating quality in terms of output of the packets on the terminal device.

13. The model learning method according to claim 12, further comprising:
calculating, by the processor, based on the acquisition statuses of other packets transmitted from the application device to the terminal device over the network, second group information indicating the acquisition statuses for each of a plurality of packet groups;
acquiring, by the processor, second quality information output from the learning model as a result of input of the second group information calculated and second communication condition information indicating communication conditions of the other packets in the network; and
outputting, by the processor, the acquired second quality information.
